(19) United States
(12) Patent Application Publication
(10) Pub. No.: US 2010/0280677 A1
(43) Pub. Date: Nov. 4, 2010

(54) Lighting and energy control system and modules

(76) Inventor: Lothar E. S. Budike, JR., Villanova, PA (US)

Correspondence Address: MCKENNA LONG & ALDRIDGE LLP, 1900 K STREET, NW, WASHINGTON, DC, 20006, US

(21) Appl. No.: 12/453,249

(22) Filed: May 4, 2009

(51) Int. Cl. G06F 1/26

(52) U.S. Cl. 700/296; 700/90

(57) ABSTRACT

The present disclosure generally relates to lighting and energy control systems. In some embodiments, a control module is provided that can facilitate installation of lighting systems and control power consumption. Control module may control a ballast coupled to one or more lamps in a light fixture or energy consuming devices on a circuit. The control module can retrofit with various junction boxes or light fixtures and thus enable energy and sensor controls to be deployed in a wide variety of lighting installations which may be inaccessible due to cost or installation constraints. Control device may include a control circuit which provides relaying and one or more interfaces to provide power controls to various devices, such as ballasts, motors, appliances, or other devices. The system may also include receivers and transmitters which can allow sensors or switches to control groups or zones of devices in the system remotely.

### CROSS REFERENCE TO RELATED APPLICATIONS

This application claims priority to U.S. application Ser. No. ##/###,### (Attorney Docket No. 28564.047.00), titled “MULTI-CONFIGURABLE LIGHTING AND ENERGY CONTROL SYSTEM AND MODULES,” filed on Apr. 28, 2009, which claims the benefit of U.S. Provisional Application No. 61/071,423, filed on Apr. 28, 2008, and U.S. patent application Ser. No. 11/599,621, filed on Nov. 15, 2006, the contents of which are hereby incorporated herein by reference for all purposes in their entirety.

### BACKGROUND

1. Field

The present disclosure generally relates to control systems and modules. More specifically, the present disclosure relates to systems and controls for lighting and other devices.

2. Discussion of the Related Technology

A building may include one or more lighting systems; heating, ventilation, air conditioning (HVAC) systems; electrical systems, etc. Typically, these systems are installed when the building is constructed and include circuitry or wiring which may be obstructed by walls, ceilings, and the like. In addition, these systems are often controlled by on or off switches.

### SUMMARY

Unfortunately, having more sophisticated power controls for the different systems in a building can be difficult because it may require re-wiring. Accordingly, investment and installation in energy controls for these systems, such as lighting systems, electrical systems, HVAC systems, boiler systems, heating systems, etc., typically does not occur. The use of power controls can result in a tremendous amount of energy savings.

Accordingly, a control module capable of controlling lighting or other energy consuming devices is provided. The control module can include an interface including an input operable to receive an input signal configured to control a level of light emitted by a light source from a receiver and a power output operable to power the receiver. The control module may further include another interface including one or more outputs configured to provide a control signal to adjust light emitted by one or more additional light sources based on the input signal.

The one or more outputs of the interface may include at least one dry contact configured to pass through the input signal. In addition, the input signal can provide on or off control to the light source and additional light sources. Alternatively, the input signal can provide dimming control to the light source and additional light sources. In some embodiments, the above-mentioned interfaces can be provided on different sides of the control module. Receivers and transmitters can also be employed to allow sensors or switches to control groups or zones of light sources remotely.

In another aspect, a lighting system capable of reducing energy consumption is provided. The lighting system can include a junction box and a control module. The control module can include an interface having a power supply line configured to provide a supply voltage to a power supply and a relay line configured to relay a signal to control light emitted by at least one light fixture using the junction box.

In an embodiment, the relay line can be operably connected to the junction box through a knock out hole. In addition, the power supply line can be operably connected to the junction box to receive the supply voltage. The control module can further include a dimming line configured to provide dimming control to a ballast provided within a housing of the at least one light fixture. The dimming line may run through a hole provided in the housing and connect with the ballast.

In some embodiments, a lighting system which includes an interface cable and a control module is provided. The interface can be operable to receive an input signal configured to control a level of light emitted by a light fixture from a receiver and a power output operable to power the receiver when connected by the interface cable to the receiver. In an embodiment, the control module can be positioned inside a housing of the light fixture.

The housing can be configured to provide a hole when a knock out piece of the housing is removed. In addition, the interface may be operable to be connected to the receiver through a first hole provided in the housing. The control module may include one or more power supply lines which exit the housing through a first hole and the interface cable may exit the housing through a second hole. Additionally, the control module can further include one or more relay lines which exit the housing through a first hole and the interface cable may exit the housing through a second hole.

Advantages and features of the disclosure in part may become apparent in the description that follows and in part may become apparent to those having ordinary skill in the art upon examination of the following or may be learned from practice of the disclosure. The advantages and features of embodiments of the present disclosure may be realized and attained by the structures and processes described in the written description, the claims, and in the appended drawings.

It is to be understood that both the foregoing general description and the following detailed description are exemplary and explanatory and should not be construed as limiting the scope of the claims.

### BRIEF DESCRIPTION OF THE DRAWINGS

The accompanying drawings are included to provide a further understanding of the disclosure, and are incorporated herein and constitute a part of this application. The drawings together with the description serve to explain exemplary embodiments of the present disclosure. Wherever possible, the same reference numbers will be used throughout the drawings to refer to the same or like parts. In the drawings:

FIG. 1A illustrates an exemplary block diagram of a lighting system capable of controlling and powering one or more light fixtures, according to an embodiment of the disclosure;

FIG. 1B illustrates an exemplary top elevation view of the control device that may be employed in the system of FIG. 1A;

FIG. 2A illustrates exemplary components which may comprise a control device, according to an embodiment of the disclosure;

FIG. 2B illustrates an exemplary circuit which may comprise the control device of FIG. 2A, according to an embodiment of the disclosure;

FIG. 3A illustrates an exemplary installation of the control device of FIG. 1A and a junction box, according to an embodiment of the disclosure;

FIG. 3B illustrates an exemplary junction box that may be employed in the installation of FIG. 3A, according to an embodiment of the disclosure;

FIGS. 4A-4B illustrate an exemplary installation of a control device of FIG. 1A and a light fixture, according to embodiments of the disclosure; and

FIGS. 5A-5C illustrate exemplary side views of a control device that may be employed, according to embodiments of the disclosure;

FIGS. 6A-6B illustrate exemplary arrangements of controls for a lighting system, according to embodiments of the disclosure;

FIG. 7 illustrates an exemplary block diagram of a lighting system capable of relaying controls to one or more light fixtures, according to an embodiment of the disclosure;

FIG. 8 illustrates an exemplary control module capable of interfacing with any type of ballast, according to an embodiment of the disclosure;

FIG. 9 illustrates a control module capable of interfacing a knock out plug provided in a light fixture, according to an embodiment of the disclosure;

FIG. 10 illustrates a control module capable of being positioned inside a light fixture and possible wiring configurations, according to an embodiment of the disclosure;

FIG. 11 illustrates a block diagram of exemplary components of a control module, according to an embodiment of the disclosure;

FIG. 12 illustrates a control module configured to control a plurality of ballasts in a light fixture, according to an embodiment of the disclosure;

FIG. 13 illustrates a control module configured to control a plurality of different ballast types in a light fixture, according to an embodiment of the disclosure;

FIG. 14 illustrates a control module configured to control a ballast using dry contact relays, according to an embodiment of the disclosure;

FIGS. 15A-15C illustrate a control module wired to control one or more light fixtures, according to embodiments of the disclosure;

FIG. 16 illustrates exemplary interfaces of a control module, according to an embodiment of the disclosure;

FIG. 17 illustrates an exemplary interface cable employed in a lighting system, according to an embodiment of the disclosure;

FIG. 18 illustrates another exemplary circuit which may comprise a control module, according to an embodiment of the disclosure;

FIG. 19 illustrates a receiver employed to communicate with one or more sensors or switches, according to an embodiment of the disclosure;

FIG. 20A illustrates a receiver capable of providing controls signals for any type of ballast, according to an embodiment of the disclosure;

FIG. 20B illustrates an exemplary circuit which may comprise a receiver, according to an embodiment of the disclosure;

FIGS. 21A-21B illustrate transmitters capable of transmitting control signals from one or more sensors, according to embodiments of the disclosure;

FIG. 22 illustrates an exemplary deployment of a transmitter and sensor, according to an embodiment of the disclosure;

FIG. 23 illustrates another exemplary deployment of a transmitter and sensor, according to an embodiment of the disclosure;

FIGS. 24A-24B illustrate exemplary circuits which may comprise a transmitter, according to embodiments of the disclosure;

FIG. 25 illustrates a circuit schematic which may comprise a transmitter, according to an embodiment of the disclosure;

FIG. 26 illustrates exemplary switches which may be employed in a lighting system, according to an embodiment of the disclosure;

FIGS. 27A-27C illustrate exemplary assemblies for a switch, according to embodiments of the disclosure; and

FIG. 28 illustrates an exemplary circuit which may comprise a switch, according to an embodiment of the disclosure.

### DESCRIPTION OF THE EMBODIMENTS

The present disclosure generally relates to lighting and energy control systems. In some embodiments, a control module is provided that can facilitate installation of new light fixtures, light sources, or other energy consuming devices. The control module can retrofit with various junction boxes or light fixtures and thus enable energy and sensor controls to be deployed in a wide variety of lighting installations that are inaccessible due to cost or installation constraints.

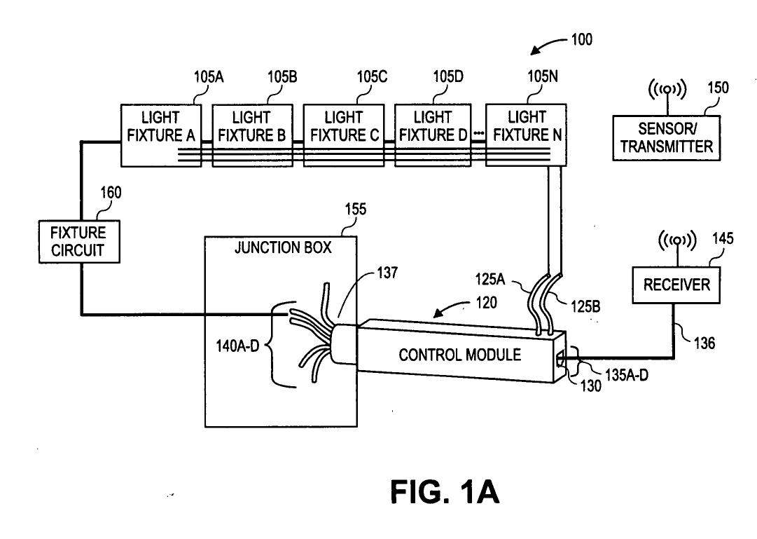

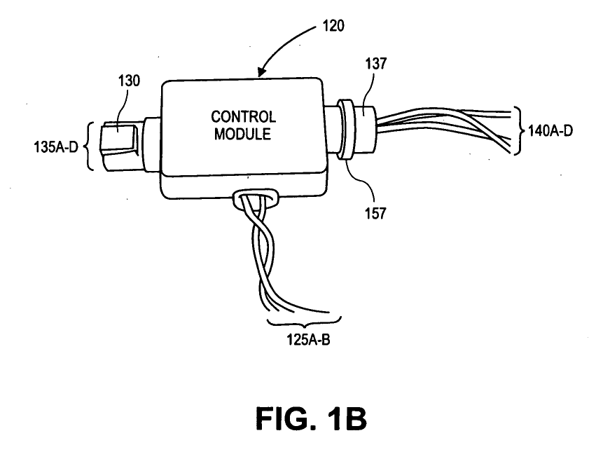

FIG. 1A illustrates an exemplary block diagram of a lighting system 100 capable of controlling and powering one or more light fixtures. As shown, a control module or device 120 communicates with a receiver 145, sensor 150, junction box 155, fixture circuit 160, and/or light fixtures 105A, 105B, 105C, 105D, and 105N (representative of any number of light fixtures) through a variety of connections. The junction box 155 can be any standard junction box existing along the power-supply “feeder” to the light fixtures 105A-N or added box by an electrician. The control module 120 draws power from the supply lines and can be wired to interrupt the flow of power to the light fixtures 105A-N—thus offering on-off control of the fixture. For certain fixtures full dimming is offered by 125A-B (as will be explained later). Light fixtures 105A-N could actually represent nearly any type of controllable load including but not limited to one or more ballasts (not shown) and one or more lamps, light bulbs, LEDs, motor, or light sources (not shown). Light fixtures 105A-N can include one or more ballasts (not shown) and one or more lamps, light bulbs, LEDs, or light sources (not shown). Communication within the system 100 may take place over one or more wires, wireless technologies, cables, or other digital or analog techniques, devices to perform these techniques, radio, a local area network (LAN), a wide area network (WAN), or the internet, for example. Of note, control module 120, receiver 145, or sensor 150 may reside on physically separate devices or be combined into the same device.

The junction box 155 may exist as part of a feeder circuit that feeds a string of light fixtures 105A-N or may be added along the conduit. For example, when a building is constructed an electrician may run the supply lines through the conduit and along that conduit may be one or more junction boxes. Into any one of these the electrician may wire up the control module 120 by powering the control module from the power that normally runs to a light fixture and then interrupting the flow downstream to light fixtures through the control module 120 so that the light fixtures can be controlled on and off via the control module 120. For example, an electrician may cut the black hot lead inside the junction box 155, and wire it up along with the white neutral to the control module 120.

Of note, although system 100 shows one receiver 145 and one sensor 150, the system 100 may include one or more receivers 145, one or more sensors 150, and one or more control modules 120. In an embodiment another interface can be added to device 120 essentially “paralleling” the wires to the second 130 interface. This could exist external to the 120 device as a “Y-cable-adaptor” or simply as another interface on the control module 120 itself. For the second interface 130, lines 135A-D can run to a second “daisy-chained” control module in another fixture. Thus one receiver 145 can control multiple control modules. In another embodiment, one or more sensors 150 may transmit control or measurement signals to one or more receivers 145 associated with different lighting zones or areas in a room, building, or hallway, for example. The control or measurement signals transmitted by sensor 150 to receiver 145 can then be sent to control modules 120 which control light fixtures 105A-N associated with the different lighting zones using addressing via dip switches, for example. Based on the transmitted control or measurement signals, light fixtures 105A-N connected or controlled by a particular control module 120 can be individually controlled. In an exemplary embodiment, a series of motion sensor, receiver 145, and control module 120 triples may be used throughout a hallway to turn lighting fixtures 105A-N on and off as an individual progressively walks down the hallway. It should be noted that other configurations of sensors 150, receivers 145, and control modules 120 may also be used.

The receiver 145 can include a wireless interface to wirelessly communicate with one or more sensors 150 or nearly any compatible wireless device, such as a computer with compatible wireless interface, wireless remote control, wireless wall switch, compatible wireless network, etc. Receiver 145 may be remotely mounted or positioned away from sensor 150 and may include a microcontroller. For example, receiver 145 can receive measurements and/or signals from the sensor 150 or a computer which can be used to operate or control light fixtures 105A-N. Based on the received signals or measurements, receiver 145 can provide control signals for light fixtures 105A-N to control module 120. In an embodiment, receiver 145 and control module 120 may advantageously reside separately to reduce electromagnetic interference (EMI) generated by ballasts of light fixtures 105A-N. For example, in some configurations of system 100, receiver 145 may be positioned outside light fixtures 105A-N and control module 120 may reside near or be entirely or partially housed within light fixtures 105A-N.

Sensor 150 can provide on/off and/or dimming controls signals for light fixtures 105A-N. The sensor 150 includes a wireless interface to wirelessly communicate with receiver 145. Various types of sensors 150 can be used in system 100, including motion, light harvest, timer, real-time-clock, remote-control, and the like. In some embodiments, sensor 150 may be positioned separately from receiver 145 because the measurements taken by sensor 150 can be improved by placing sensor away from light fixtures 105A-N and receiver 145. For example, in some embodiments when sensor 150 comprises a light harvesting sensor, light fixtures 105A-N can interfere with ambient light being measured by sensor 150. Thus, separating sensor 150 from receiver 145 can improve operation of system 100. In addition, splitting the functionality of system 100 across the control module 120, receiver 145, and sensor 150 can improve performance of system 100, allow for ease of installation, and reduce installation costs by minimizing wires, for example.

Control module 120 can be installed in a variety of configurations to provide power and controls to light fixtures 105A-N. For example, control module 120 may control one or more ballast(s) which may be coupled to one or more light sources, light bulbs, lamps, LEDs, and the like. In addition, control module 120 may control other energy consuming devices (not shown), such as a motors, heaters, appliances, or other devices having on/off switches. Control module 120 may also be connected to junction box 155, which can advantageously allow fixture circuit 160 to control light fixtures 105A-N when they are strung together. In some embodiments, control module 120 may be connected or wired to junction box 155 directly or through other intermediaries, conduits, or circuits. Control module 120 may include one or more interfaces, such as such as primary interface 137, secondary interface 130, and dimming lines 125A-125B which provide various outputs and inputs as will be further described herein. These interfaces can be combined into the same interface or further divided into separate interfaces. Control module 120 may also include a power supply (not shown) to supply voltage to secondary interface 137, receiver 145, or other components of system 100.

FIG. 1B illustrates an exemplary top elevation view of the control module 120 that may be employed in the system of FIG. 1A. In the illustrated embodiments, control module 120 may include dimming lines 125A-B for providing a dimming signal to control a dimming ballast (not shown) of light fixtures 105A-N. In exemplary embodiments, dimming lines 125A-B can be purple (or violet) and gray dimming lines and may be made from 18 American wire gauge (AWG) stranded wires. For example, purple dimming line 125A may provide a 0-10 Volt (V) dimming signal and gray dimming line 125B may provide a reference to ground. In addition, control module 120 can include a primary interface 137 which provides controls to light fixtures 105A-N, for example. Primary interface 137 may provide physical/electrical isolation and control of the primary power of light fixtures 105A-N or another load device, such as a motor, heater, or other energy consuming device. For example, primary interface 137 may be coupled to one or more ballasts, such as dimming or non-dimming ballasts, to control power to light fixtures 105A-N.

Primary interface 137 can include one or more primary high-voltage input or outputs, such as a relay wires 140A-B and primary power supply lines 140C-D, for example. Relay wires 140A-B may include two red-color 6 inch leads of 14 American wire gauge (AWG) stranded wires, rated to 105 degrees Celsius (C.) and/or 600 Volts (V), for example. Relay wires 140A-B may be connected to relay contacts on the relay device to provide pass through or dimming signals to control light fixtures 105A-N from receiver 145, for example. Of note, dimming lines 125A-B (as described above) and relay wires 140A-B may also be configured to control other ballast types including standard on/off ballasts, step ballasts, or hi/low ballasts. The primary power lines 140C-D may be black and white wires of 18 American wire gauge (AWG) and have substantially similar characteristics as relay wires 140A-B. Primary power lines 140C-D may provide power or to a power supply (not shown) of control module 120.

Control module 120 may further include a secondary interface 130 which can provide low voltage output features to receiver 145, for example. As shown, secondary interface 130 may include a plurality of pins, outputs, or inputs 135A-D. Secondary interface 130 can be a low-cost jack of reliable construction, such as a small class 1 or 2 telephone plug, RJ11, RJ14, or RJ45 plug. In exemplary embodiments, when secondary interface 130 comprises a jack it may have the following pin assignments: pin 135A may provide an input for on/off control of lighting fixtures 105A-N, pin 135B can be a ground reference for other voltages provided, pin 135C may provide an input for controlling a dimming ballast, such as 0 to 10 Volts (V), and pin 135D may provide a power output, such as 12 Volts (V). Pin 135D may be used to provide power to receiver 145, for example. Another RJ-11 jack can be added to the first whereby the lines from the first are paralleled to the second. This then can permit “daisy-chaining” of additional control modules from one receiver offering common control and economic advantage.

In exemplary embodiments, control module 120 may be operatively coupled to receiver 145 through secondary interface 130 via a secondary interface cable 136 (see FIG. 1). Control module 120 can then receive control signals from receiver 145 via input pins 135A and 135C. Control module 120 may implement a relay and provide dimming or pass through signals, which may be based on a signal received from input pins 135A and 135C, to fixture circuit 160. The output signals from the relay and pass through signals, such as primary interface 137 and dimming lines 125A-B, can then be coupled to one or more ballasts of light fixtures 105A-N to control the quantity or amount of light emitted.

Secondary interface 130 can facilitate installation of control module 120 by reducing the amount of wires or cable used to connect receiver 145 or another device. For example, a single cable, such as secondary interface cable 136, can be used to connect secondary interface 130 to receiver 145. In addition, secondary interface 130 can reduce the amount of wire needed to control ballast(s) of light fixtures 105A-N because of the closer proximity of control module 120 to ballast(s) in some installations. For example, an electrician or installer of system 100 may need to run dimming lines 125A-B a short distance inside light fixtures 105A-N to a ballast.

Of note, the control module 120 can be configured for integration into any existing lighting fixture or lighting system and eliminate the need for any customized controllers for a particular ballast design. In addition, the control module 120 may operate one or more lighting fixtures or can be connected to a standard electrical junction box to provide control to an entire circuit. In some embodiments, the control module 120 may receive one or more input signals from a receiver 145. The receiver 145 may receive power controls or measurements for operating light fixtures which may be transmitted wirelessly, for example, from a variety of sensors, such as light harvesting or motion control, or computing devices.

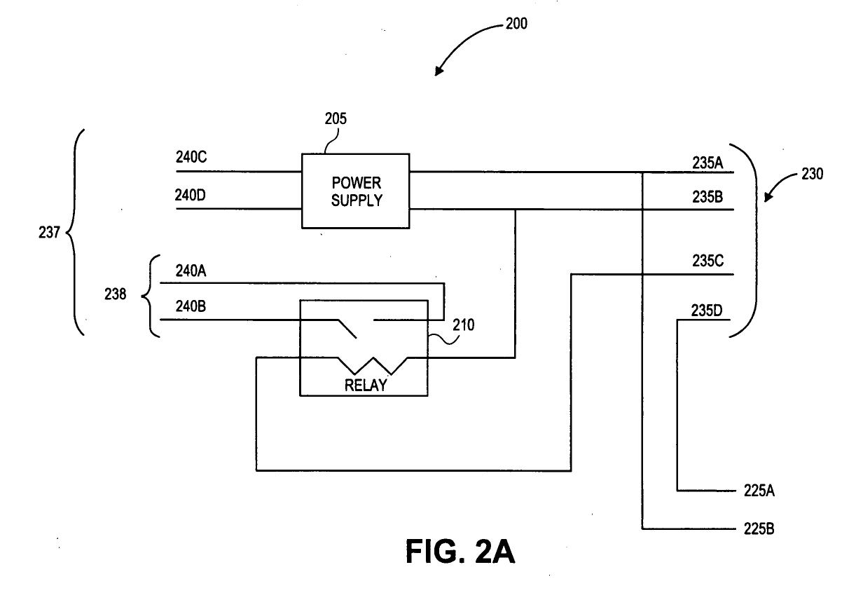

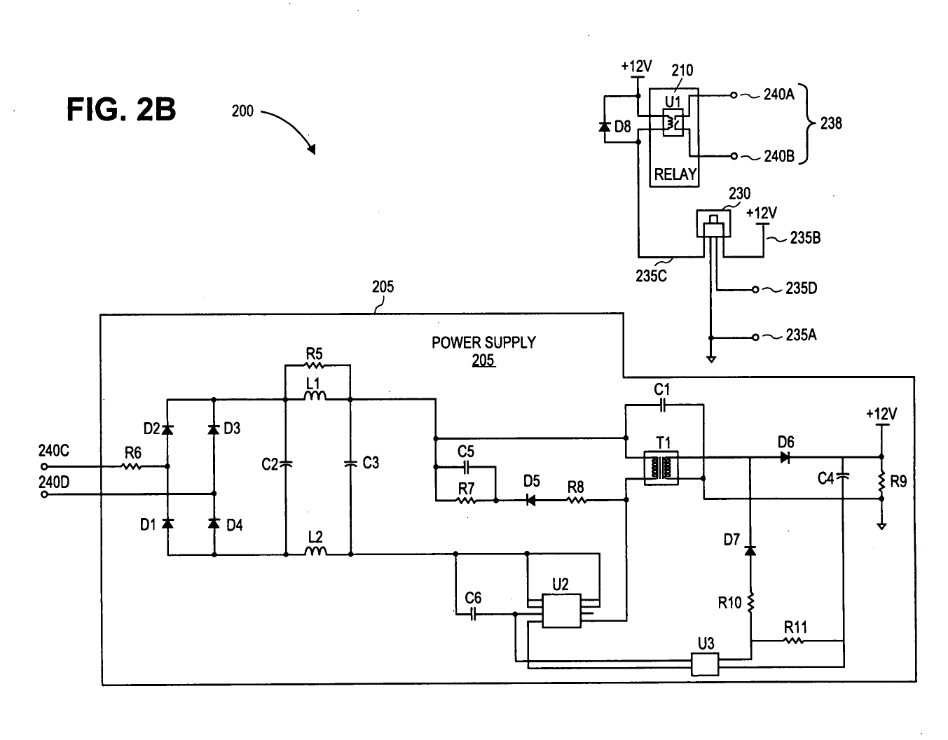

FIG. 2A illustrates exemplary components which may comprise a control device 200. As shown control device 200 can include a power supply 205, relay 210, dimming lines 225A-B, secondary interface 230, and primary interface 237. Generally, power supply 205 can be a switching or linear supply and may be isolated to allow primary high-voltage lines, such as primary power lines 240C-D which carry approximately about 120 VAC to approximately about 277 VAC, to be separated from lower-voltage lines and other circuitry. While one relay is shown connected to secondary interface 230 for control, it may be extended to more than one relay 210 in the control device 200 via a higher pin-count connector at secondary interface 230. This can allow for control of step and high/lo ballasts or simply multiple ballasts in the same fixture.

Power supply 205 can be capable of producing approximately about 12 volts of direct current (VDC) at approximately about 150 milliamperes (mA). The selection of approximately 12 volts is exemplary, and other output voltages may be accommodated with a different power supply design to handle other voltages and sensors such as 24 volts infrared, ultrasonic, and light-sensitive sensors. As shown, power supply 205 may be connected to primary power lines 240C-D to receive power. Relay 210 may consume approximately about 70 mA of this power when on. The remaining amount of power produced by power supply 205 (approximately about 80 mA) can be sent to pin output 235B of secondary interface 230 for use by energy consuming devices, such as receiver 145. Power supply 205 can use a tapped transformer to accommodate differing supply voltages or may be a “universal input” power supply. In exemplary embodiments, when power supply 205 comprises a universal-input switching power supply it may generate power-line supply voltages from as low as approximately about 85 VAC to over approximately about 377 VAC.

Relay 210 can be a 5 amp, 277 VAC or 20 amp, 277 VAC compatible relay or a semiconductor device-switch. For example, relay 210 can be a power relay, such as manufacturer part number FTR-K3JB012W made by Fujitsu Limited® of Tokyo, Japan or a semiconductor switch, such as a triac or another alternative. In addition, relay 210 may be controlled via a semiconductor device such as a properly biased transistor, MOSFET or opto-isolator. This addition may allow for lower return currents over secondary interface 230 than what a relay 210 may permit. It may also allow relay 210 to remain on when secondary interface cable 136 is not plugged into secondary interface 230 of control module 200.

In the illustrated embodiments, relay 210 may include a dry contact output 238 and primary power lines 240C-D. For example, dry contact output 238 can include two relay wires 240A-B to control additional energy devices. Dry contact output 238 can advantageously allow control module 200 to control a wide variety of additional devices. Most notably, these devices are of the form which may require independent and different—in terms of isolation need—supply and/or loads. For example, as light fixtures 105A-N, without having to inventory the supply voltage of additional devices and/or adjust power supply 205 to create additional supply voltage for the additional devices.

Secondary interface 230 may include pin 235A to provide a ground reference for other voltages provided, pin 235B to provide a power output, such as 12 Volts (V), pin 235C to provide an input for on/off control of lighting fixtures 105A-N, and pin 235D to provide an input for controlling a dimming ballast, such as 0 to 10 Volts (V). Secondary interface 230 may be coupled to receiver 145 via a secondary interface cable 136 (see FIG. 1) to provide power to receiver 145 and receive control signals for light fixtures 105A-N. As shown, dimming lines 225A-B can be connected directly to secondary interface pin 235D and pin 235A of power supply 205 respectively, to provide dimming signals to a ballast from receiver 145. In addition, secondary interface pin 235B can be connected to relay 210 to relay on/off control signals from receiver 145 using dry relay contacts 240A-B.

FIG. 2B illustrates an exemplary circuit which may comprise the control module 200 of FIG. 2A. Control module 200 can include an isolated universal-input switching power supply 205, relay 210, secondary interface 230, and primary power lines 240C-D. As shown, secondary interface 230 and its input and output pins 235A-D may be provided as a RJ-11 jack. As further shown, relay 210 can include dry contact output 238, such as dry relay wires 240A-B. Although control module 200 as illustrated may include certain isolators or passive elements, a variety of different elements can be used interchangeably depending on the embodiment. Additionally, control module 200 can be implemented as a digital circuit.

Control module 200 can be configured to provide one or more output signals based on the input signals from receiver to control one or more ballasts of light fixtures, for example. In an embodiment, control module 200 may include a controller to provide output signals to control the light fixtures. Alternatively, a controller may be provided externally, such as on receiver, and control module 200 may relay the control signals provided by the receiver.

The control module may provide relaying and have outputs coupled to one or more interfaces to provide control and power to various devices, such as ballasts, motors, appliances, or other devices having on/off switches. For example, the one or more output signals can be used to provide dimming or on/off control to lamps or light sources coupled to the one or more ballasts. In addition, the outputs can be coupled to a junction box to control a plurality of light fixtures or lighting areas which may be operatively coupled to the junction box through a circuit or wiring, for example.

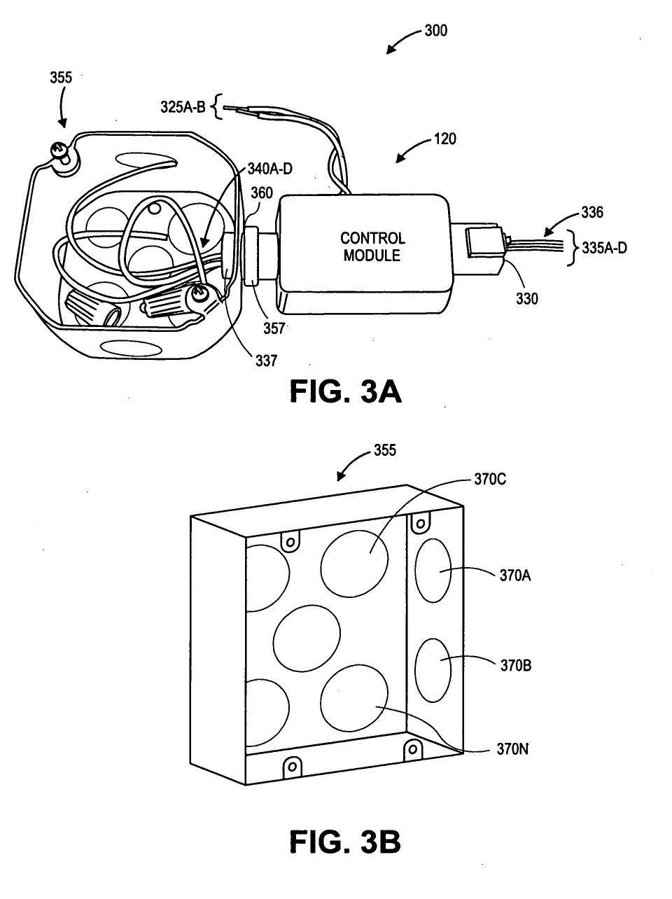

FIG. 3A illustrates an exemplary installation 300 of the control device 120 of FIG. 1A and a junction box 355. As shown, control device 120 may be coupled to junction box 355 by knocking out a standard piece of junction box 355 and inserting primary interface 337 through a knock out hole 360. Additionally, junction box 355 may include other cables or wires which may exit through other knock out holes (not shown) to connect to fixture circuit 160, for example. In this through the knock-out installation, junction box 355 can include lines from a supply voltage to supply power to primary power lines 340C-D of control module 120. In addition, junction box 355 can also include feeder lines that run to lighting fixtures 105A-N and/or a string of lighting fixtures.

In the illustrated embodiment, primary interface 337, relay wires 340A-B and primary power lines 340C-D may be inserted into knock out hole 360. A stop band 357 can be used to snap or lock primary interface in knock out hole 360. Relay wires 340A-B and primary power lines 340C-D may be then be connected to the supply voltage through wires (not shown) or feeder lines (not shown).

Of note, primary supply lines 340C-D can be positioned inside the junction box 355, while low voltage dimming lines 325A-B and/or secondary interface 330 can positioned outside the junction box 355. This can advantageously maintain physical separation and electrical isolation for safety and to meet building code requirements. In addition ballasts or alternate load devices, such as dimmable ballasts in a light fixture or string of light fixtures, can be hooked up to dimming lines 325A-B. For example, depending on code requirements, this connection can be via a regular class II wire, plenum rated wires, or by running a separate conduit for these lines. In addition, if there are no dimmable ballasts or alternate load devices, dimming lines 325A-B can simply be terminated or capped off.

In some embodiments, where light fixtures may be mated in a string like manner, such as side by side, or so called “stringer” applications, primary interface 337 can inserted into a knock-out hole (not shown) of junction box 355. This can allow primary circuits, such as fixture circuit 160, to be operatively coupled to control module 120. Wiring from fixture circuit 160 or other circuits can then be wired within the junction box 355 or primary outlet box to receive control signals from control module 120. In addition, this configuration advantageously allows low-voltage lines, such as secondary interface cable 336 to be kept outside junction box 355 at a safe distance from primary circuit lines.

FIG. 3B illustrates an exemplary junction box 355 that may be employed in the installation 300 of FIG. 3A. Junction box 355 can be used to control a string of light fixtures 105A-N, for example. Advantageously, junction box 355 can allow lighting system 300 to be installed quickly and safely. Junction box 355 may include one or more pre fabricated knock-out or punch out pieces 370A-N on the sides to allow wires and cables, such as power wires, and the like to be run into and out of light fixtures 105A-N. Punch out pieces 370A-N can be approximately about 0.885 inches in diameter and when removed can create holes in light fixtures 105A-N.

For example, a string of light fixtures 105A-N can include a feeder-path along one or more junction boxes 355. When the punch out hole 370A-N is knocked out of a junction box 355, the primary interface 337 of control device 120 can be connected. Additionally, if no junction boxes 355 are present along the feeder-path, junction boxes 355 can easily be installed to interface with the primary interface 337 of control module 120. For example, junction boxes 355 can be installed in the ceiling or mounted to a wall within a residential or commercial facility. Notably, a device load can be controlled by relay lines 340A-B of control module 120 when junction boxes 355 are used, for example.

When knock out pieces 370A-N are removed, knock out holes can be created which allow for physical separation of incoming primary power supply lines, such as approximately about 120-277 VAC, and the 12 V low voltage control lines. This physical separation can greatly improve the safety of a system installation 300. In addition junction box 355 can be placed anywhere in a building or appear anywhere in a building.

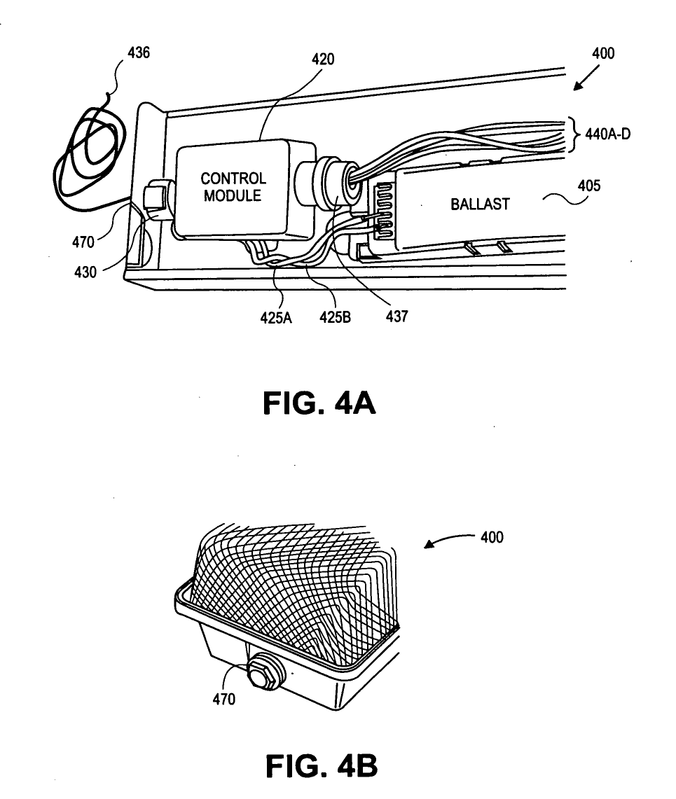

FIGS. 4A-4B illustrate an exemplary installation of the control module 420 of FIG. 1A and a light fixture 400. In FIG. 4A, control module 420 can be housed or positioned within light fixture 400 completely. Alternatively, a portion of control module 420 can be positioned within light fixture 400, such that control module 420 is positioned partially inside light fixture 400. As best shown in FIG. 4B, light fixture 400 can include a punch or knock out piece (on one or more sides of light fixture 400. Knock out pieces 470 may be approximately about 0.885 inches in diameter. When knock out piece 470 is removed, power lines can be run into fixture to control module 420, and in particular, to primary power lines 440C-D of primary interface 437.

With continued reference to FIG. 4A, control module 420 can be inserted completely inside light fixture 400. Control module 420 can be mounted or positioned inside light fixture 400 using double-sticky foam tape or attached via one or more screw holes (not shown). As shown, dimming lines 425A-B can be wired to ballast 405. Primary power lines 440C-D can be coupled to power supply lines provided outside of light fixture 400 by running them through a primary knock out hole (not shown) provided on a primary side of light fixture 400. In addition, relay lines 440A-B may be run outside the primary side of light fixture 400 using the primary knock out hole and run to other light fixtures or a junction box (not shown). Secondary interface 430 may be positioned inside a secondary knock out hole 430 and/or secondary interface cable 436 may run outside secondary knock-out hole 430 and connected to receiver 145, for example. This can advantageously allow low voltage lines, such as dimming lines 425A-B and high voltage lines, such as primary supply lines 440C-D to remain inside the fixture and/or separate from secondary interface cable 436, which can be of a substantially low voltage.

In addition, control module 420 may be wired to light fixture 400 in a junction box like methodology (not shown). For example, control module 420 can be positioned outside of light fixture 400, and primary power lines 440C-D and relay lines 440A-B can be run through a knock-out hole in light fixture 400 from the outside. Dimming lines 425A-B may then optionally be run through another knock out hole to a dimming ballast.

Notably, when control module 420 may be installed inside light fixture 400, primary power lines 440A-D of primary interface 437 may exit by virtue of a standard “knock-out” hole mating piece (not shown) located in light fixture 400. In these so called “in fixture” applications, control module 420 may be partially or fully inserted or housed in light fixture 400. The knock-out piece can be sized and/or configured to accommodate primary interface 437 or other interfaces described herein, such as secondary interface 430, to be inserted and fed through the knock out hole.

Of note, relay lines 440A-B and primary power lines 440C-D exiting through the knock out hole can allow lighting controls to be relayed across a plurality of light fixture 400. This can advantageously additional light fixtures which make up a lighting area to be operated or controlled in similar manner, such as based on sensor 150, for example. In addition, if additional light fixtures include a dimming or other ballast (not shown), the primary power lines 440C-D and/or dimming lines 425A-B can also be connected to the ballast. Secondary interface cable 436 can be fed through the knock out hole and/or placed over primary interface 437 to carry input and output signals 435A-D to receiver 145 which may reside outside light fixture 400. Because the design of light fixture 400 can vary, in some installations it may be beneficial keep secondary interface cable 436 physically separate from primary circuit lines, such as fixture circuit, to avoid malfunction of light fixtures. A second knock out hole may be used to maintain separation between secondary interface cable 436 and primary circuit lines.

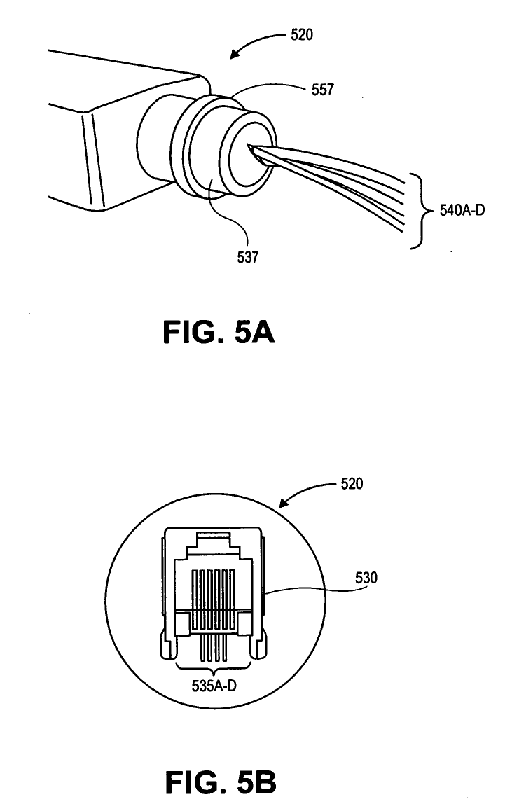

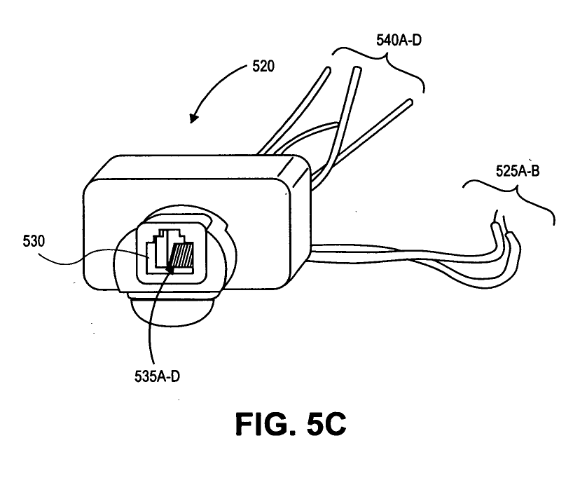

FIGS. 5A-5C illustrate exemplary side views of the control device 520 that may be employed in the system of FIG. 1A. As shown in FIGS. 5A-5C, control device 520 may comprise dimming lines 525A-B, secondary interface 530, and primary interface 537. Dimming lines 525A-B can provide a dimming signal to control dimming ballast(s) which may be housed inside one or more light fixtures 105A-N.

Primary interface 537 may provide physical or electrical isolation and control of the primary power of light fixtures or another load device. Primary interface 537 can include one or more primary high-voltage inputs or outputs, such as primary power supply lines 540C-D and relay wires 540A-B, for example. Relay wires 540A-B may be connected to relay contacts on a relay device to provide pass through or dimming signals to control light fixtures 105A-N or another load device based on input signals transmitted from receiver 145. Of note, dimming lines 525A-B (as described above) and relay wires 540A-B may also be configured to control other ballast types including standard on/off ballasts, step ballasts, or hi/low ballasts. Primary power lines 540C-D may provide power to a power supply (not shown) of control module 520.

Secondary interface 530 may provide low voltage output features to a receiver and may include a plurality of pins, outputs, or inputs 535A-D. In addition, secondary interface 530 can be a low-cost jack of reliable construction, such as a small class 1 or 2 telephone plug, RJ11, RJ14, or RJ45 plug. Secondary interface 530 can comprise a jack having the following pin configurations: pin 535A may provide an input for on/off control of lighting fixtures, pin 535B can be a ground reference for measuring other voltages provided, pin 535C may provide an input for controlling a dimming ballast, such as 0 to 10 Volts (V), and pin 535D may provide a power output, such as 12 Volts (V). Pin 535D may be used to provide power to a receiver 145, for example.

As best shown in FIG. 5A, a stop band 557 may also be provided on the primary interface side (or high power side) of control module 520. Stop band 557 can cover any part of the circumference of primary interface 537 or extend around primary interface 537 to facilitate installation. In exemplary embodiments, stop band 557 can have snap-in detail which can allows primary interface 537 and stop band 557 to snap into a knock out hole of a light fixture and allow relay wires 540C-D and primary power lines 540A-B to be secured. Alternatively, stop band 557 or primary interface 537 may be threaded and/or connected with a standard nut to knock out hole.

As depicted in FIGS. 5B-5C, secondary interface (or low voltage interface) 530 may comprise a standard jack, such as RJ-11. Secondary interface 530 may include a plurality of internal wires which are interfaced into a jack, such as pins 535A-D described above. Additional configurations can be used for the internal wires or pins, such as 0-5 mA output, modulation digital output frequencies, and/or PLC interface communication.

Of note, when control module 520 may not utilize a secondary interface 530 comprising an interface jack, duplicate (or alternate) low voltage lines or wires may be provided. Duplicate low voltage wires may include any of the previously described combinations of features and controls for control device 520. For example, these low voltage lines can include the following: a 0-10V output to ballast(s), a 0-5 mA output to another device (e.g. receiver 145), a low voltage coupler to connect multiple devices, or remote output power. In addition, these lines may be configured to accept low voltage inputs or isolated contact closures from third party motion, daylight, or other lighting based sensors or computing devices.

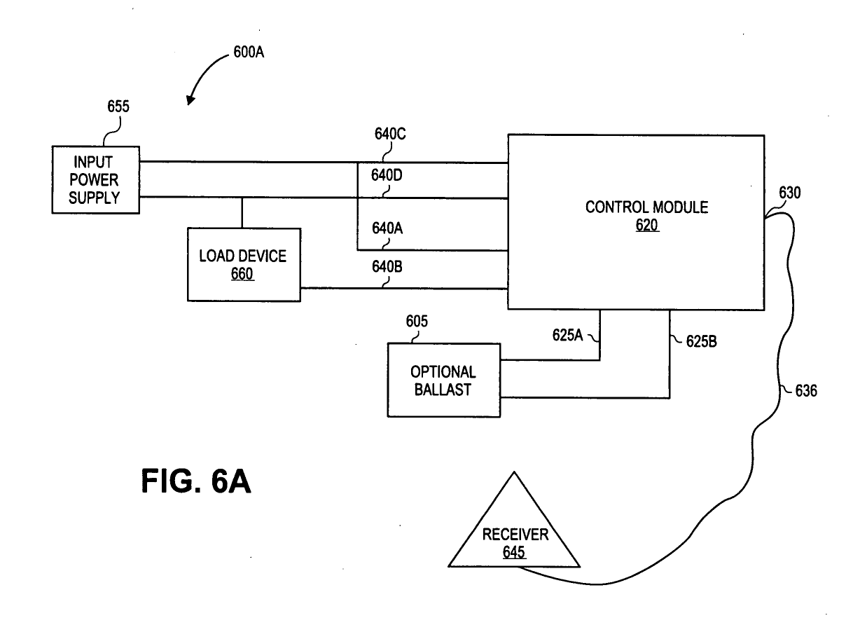

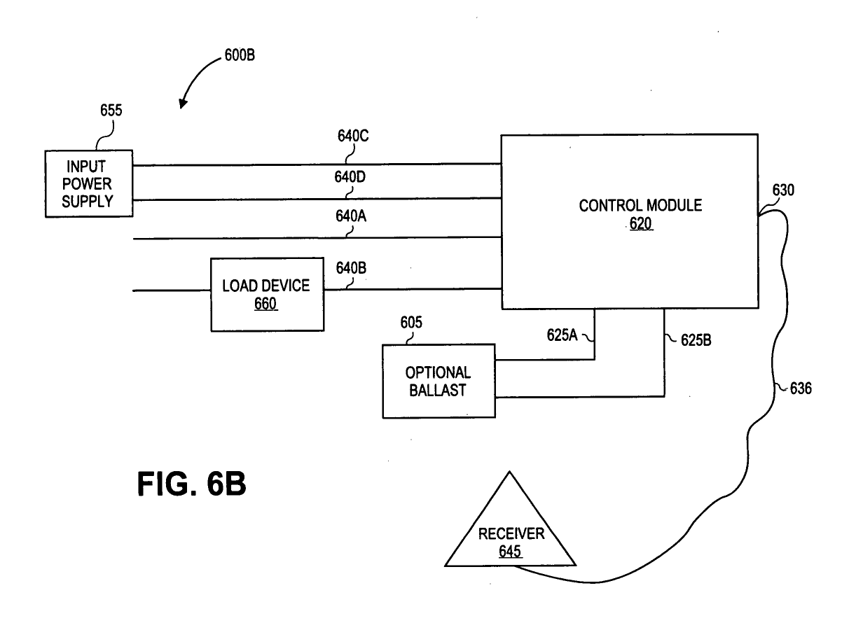

FIGS. 6A-6B illustrate exemplary arrangements of controls for a lighting system. In both FIGS. 6A-6B, systems 600A and 600B can include control device 620 optionally connected to a dimming ballast 605 using dimming lines 625A-B. Additionally, receiver 645 can be connected via secondary interface cable 636 to control device 620. Of note, receiver 645 may be connected to one or more sensors (not shown) via a cable or wireless interface, such as radio. Any type radio signal in the compatible format of the wireless receiver 145 can control the device (via transmission to receiver 145, for example). Although sensors are shown as control elements, the wireless signal can come from a remote wireless control device (e.g. wireless wall switch, handheld remote, network-to-radio-compatible device, etc.). Systems 600A and 600B may also include an input power supply 655, such as an AC universal input power supply.

As shown in FIG. 6A, a combination of relay lines 640A-B and input power supply 655 can be wired to control substantially the same supply and load voltage to load device 660. Load device 660 can be a ballast (regular or dimmable), motor, various light sources, or other relay contactor. As shown in FIG. 6B, a combination of relay lines 640A-B and input power supply 655 can alternatively be wired to control a load device 660 of a substantially different supply than load voltage. Advantageously, input power supply lines 640C-D, which may be black and white wires, can be wired to be an always on back up supply to provide always on power to load device 660, such as for critical time control. Additionally, relay lines 640A-B can control a less critical or higher power load. Alternatively, relay lines 640A-B may control a low-voltage HVAC contactor.

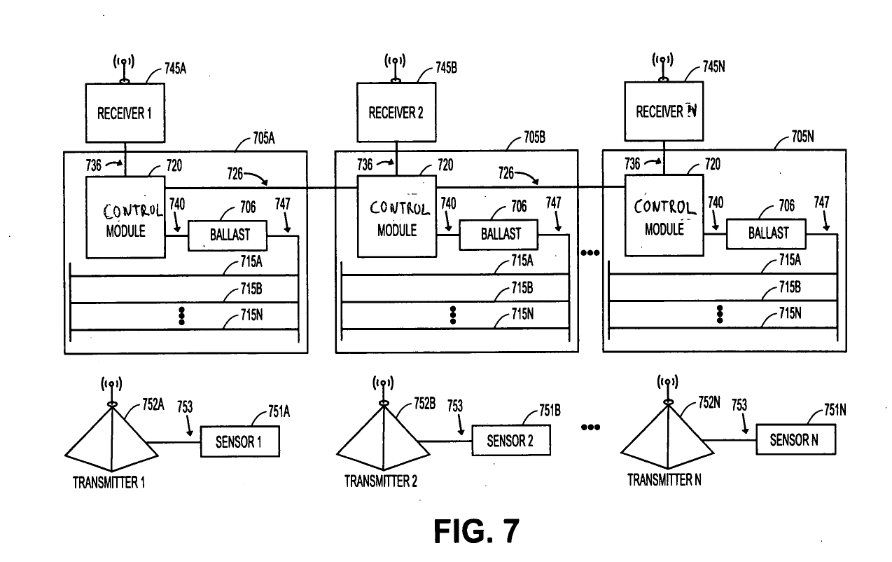

FIG. 7 illustrates an exemplary block diagram of a lighting system capable of relaying controls to one or more light fixtures. As shown in FIG. 7, light fixtures 705A-N may include a control module 720. Various components of the lighting system, such as one or more receivers 745A-N, sensors 751A-N, and transmitters 752A-N may be in communication or connected via cables, wires, a wireless interface, circuits, or conduits.

In the illustrated embodiment, receivers 745A-N may include a communication interface (not shown), such as a wireless interface to receive signals or control commands from sensors 751A-N in the field or switches. Transmitters 752A-N may send the control commands from sensors 751A-N. Receivers 745A-N may be mounted outside light fixtures 705A-N to reduce interference and improve communication with transmitters 752A-N. For example, receivers 745A-N may be integrally mounted to a luminaire housing exterior surface or remotely in the case of a pendant-mounted luminaire. A low voltage signal output from receivers 745A-N may connect to control module 720 to provide input control signals for light fixtures 705A-N over an interface cable 736.

Control module 720 may be installed into light fixtures 705A-N. In an embodiment, control module 720 may be configured to act as an interface between a ballast 706 and receivers 745A-N. Control module 720 typically provides control signals to ballast 706, which in turn operates one or more lamps 715A-N. Advantageously, control module 720 can provide plug and play interfaces so light fixtures 705A-N can be equipped with any type of control features or ballast configurations and still integrate with the system. For example, control module 720 may provide control to a variety of ballasts 706, including standard on/off ballasts, full dimming ballasts, step ballasts, hi/lo ballasts, etc. As shown in the illustrated embodiment, control modules 720 can be relayed together by a chaining cable 726. This can advantageously allow one receiver 745, transmitter 752A-N, and/or sensor 751A-N to control multiple light fixtures 705A-N.

Transmitters 752A-N may interface with one or more sensors 751A-N. For example, transmitters may interface with sensors 751A-N which may be mounted on a ceiling or wall of a room, hallway, etc. Transmitters 752A-N may be connected to sensors 751A-N via a cable interface 753, for example. In some embodiments, transmitters 752A-N may be capable of receiving controls or other signals from one or more sensors 751A-N via cable interface 753 in order to adjust the light emitted by light fixtures 705A-N. In addition, transmitters 752A-N can set time delays, power sensors 751A-N, and transmit control commands to receivers 745A-N. A variety of sensors 751A-N may be used in conjunction with transmitters 752A-N, including light harvest, motion, a combination of light harvest and motion, occupancy, etc.

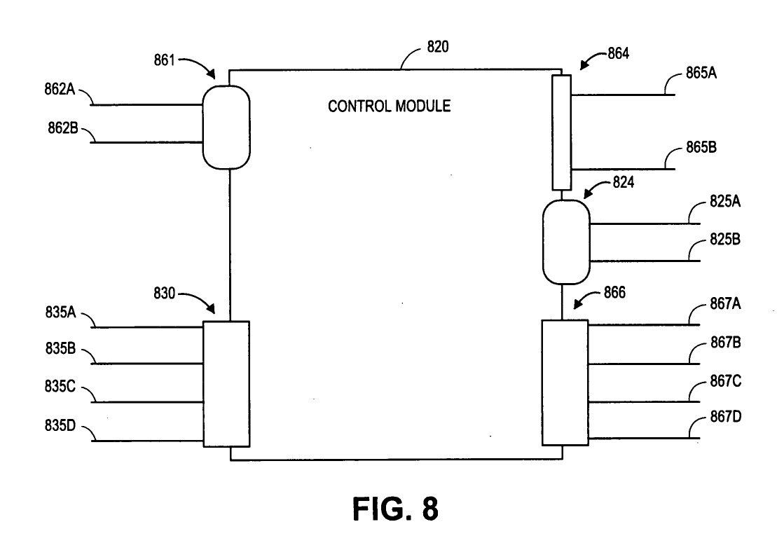

FIG. 8 illustrates an exemplary control module 820 capable of interfacing with any type of ballast. Control module 820 may include any number of interfaces which can interface receivers and any type of ballast. These interfaces may include inputs and outputs which carry signals to control ballasts or provide power. In the illustrated embodiments, control module 820 includes a power interface 861 to provide power. The power interface 861 may include power supply lines 862A-B to receive power, such as 85 VAC to 277 VAC, from an external source. Power supply lines 862A-B may be black/white wires and be connected to an integrated power supply (not shown) of control module 820.

Control module 820 may further comprise a receiver interface 830 having inputs and outputs 835A-D. As described in further detail below, receive interface 830 may provide 12 Volts of power, return, on/off control, dimming control, step control, high/low control, or dual ballast switching control. The receiver interface 830 can be connected to a receiver by running a cable through a knock out hole provided in a light fixture. Once connected, power may be provided to receiver, and control signals for ballast control may be sent to control module 820 over receiver interface 830.

In addition, control module 820 can include a chaining interface 866 to chain the control module 820 to another control module. The chaining interface 866 may include lines 867A-D which may mimic the inputs and outputs 835A-D of receiver interface 830. This can advantageously allow a control module 820 to control multiple control modules which can be provided in the same light fixture or other light fixtures, and reduce the number of receivers needed in a lighting system.

As further shown, control module 820 may include a dimming interface 824 having dimming lines or pigtails 825A-B. Dimming pigtails 825A-B can provide low voltage dimming control for dimming ballast fixtures using 0-10 Volt dimming lines. In addition, control module 820 can include a hot relay interface 864. In the illustrated embodiment, hot relay interface 864 includes two hot relay connectors 865A-B to enable full on/off control of step or dual ballasts, for example. Alternatively, one, three, or more hot relay connectors may be used.

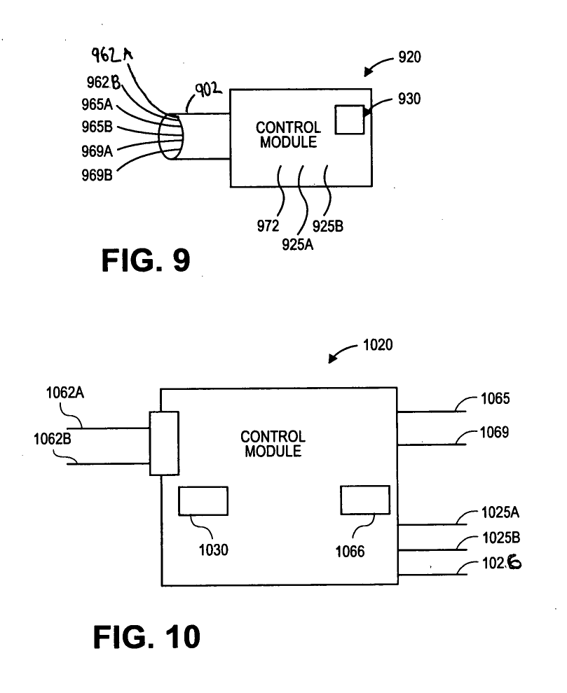

FIG. 9 illustrates a control module 920 capable of interfacing a knock out plug provided in a light fixture. As shown, control module 920 may include an interface 902 for connecting with the knock out plug. Interface 902 may include power supply lines 962A-B (e.g. black/white wires) and two sets of relay contacts 965A-B and 969A-B. The relay contacts 965A-B and 969A-B can be used to control a variety of ballast types. In addition, control module 920 may include a return line 972, two sets of dimming lines 925A-B, and a jack 930. Jack 930 can have 4 or 6 pins to support an extra relay and dimming line and be used to relay control signals to multiple control modules.

Control module 920 can advantageously interface more than one ballast, such as standard on/off ballasts, full dimming ballasts, step ballasts or hi/lo ballasts. In order to control these ballasts, control module 920 can be placed inside the light fixture and shaped consistent with space available and offer wiring convenience, for example, by choice of the locations of the connections on control module 920 and to a fixture assembler. The form factor of control module 920 can be selected to be a rectangular or cigar shape in order to conform to a shape of a light fixture, as ballasts typically have long, skinny, and rectangular shapes with plenty of length afforded by long adjacent bulbs.

FIG. 10 illustrates a control module 1020 capable of being positioned inside a light fixture and possible wiring configurations. As shown, control module 1020 includes lead lines 1062A-B for supplying power. Control module 1020 can include a receiver jack 1030 which can be connected to a receiver. In addition, control module 1020 may include a chaining jack 1066 which may carry substantially the same signals as the receiver jack 1030. The chaining jack 1066 can allow one receiver to drive a “daisy-chained” similar control module down stream. Also shown, control module 1020 can include two dimming 0 to 10 Volt lines 1025A-B which share the same return 1026. The relay contacts 1065 and 1069 of control module 820 can be dry contacts. Alternatively, one-contact of a relay (not shown) can be tied to the black hot lead which can offer offering switched black to a ballast connected to relay contacts 1065 and 1069. In addition, depending on the type of ballast, the connections from control module 1020 to a ballast may be either wire pigtails or printed circuit board (PCB) terminal blocks.

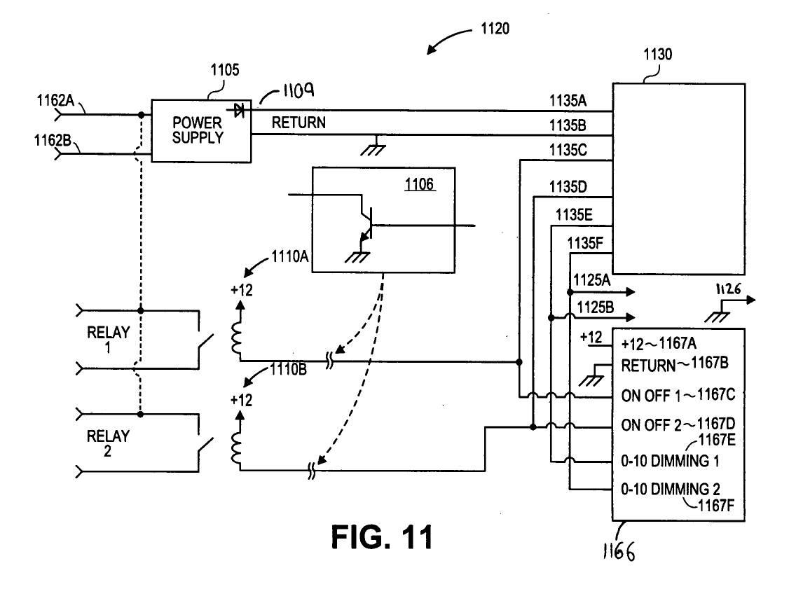

FIG. 11 illustrates a block diagram of exemplary components of a control module 1120. As shown, control module 1120 can include a power supply 1105, various interfaces or jacks, and relays 1110A-B. In the illustrated embodiment, power line inputs 1162A-B, such as universal 85 to 277 VAC line inputs can run to power supply 1105. The power supply 1105 can be a tapped transformer, switching supply, etc. In a switching supply design, isolation for UL HyPot is afforded by magnetic isolation of anything on the line-supply-side from anything on the low power side 1109. As shown, a diode (e.g., regular or schottky) may be provided on the low power side 1109, to provide approximately 12 Volts and can be utilized to enable chaining by a chaining interface 1166 of control module 1120 in a “diode-or” configuration of 12 Volt supply voltages. For example, each 12 Volt supply when daisy-chained may cause issues for other daisy-chained supplies if a diode is not used.

As further shown, the low power side 1109 offers power to the two relays 1110A-B, as well as receiver jack 1130 and chaining jack 1166 of control module 1120 which can be paralleled. Receiver jack 1130 can be connected to a receiver to provide power over pin 1135A, pin 1135B may be a return, pins 1135C-D may provide input signals for on/off controls, and pins 1135E-F may provide input signals for dimming controls. As shown, chaining jack 1166 may include pins 1167A-F which can be operably connected to the respective pins 1135A-F of receiver jack 1130 for relaying or daisy-chaining purposes. Of note, although receiver jack 1130 and chaining jack 1166 jacks are depicted as having 6 pins, 4 pin jacks can also be used.

Dimming line outputs 1125A-B which can share a common return 1126 are also shown. In addition, dimming line outputs 1125A-B can be connected to dimming lines 1135E-F of control jack 1130 and tied to dimming line inputs of one or more ballasts to provide dimming control. The relays 1110A-B can be used to control an external line-voltage load. As shown, relays 110A-B may be dry-contact closures in the case of isolation needs, but tying of the supply voltage to one side of the relay can afford “switched-power” and may simplify external wiring. Alternatively, the relays 1110A-B can be a semiconductor switch. In some embodiments, when relays 1110A-B draw too much power during operation, an optional lower power drive circuitry 1106 can be used which may take the form of a transistor or MOSFET buffer. Without this feature, daisy-chained relays may “add-up” their relay current on the return-line back to a receiver and on its switching device. Adding the blocked-feature of low-power drive circuitry 1106 can reduce the return-line current significantly.

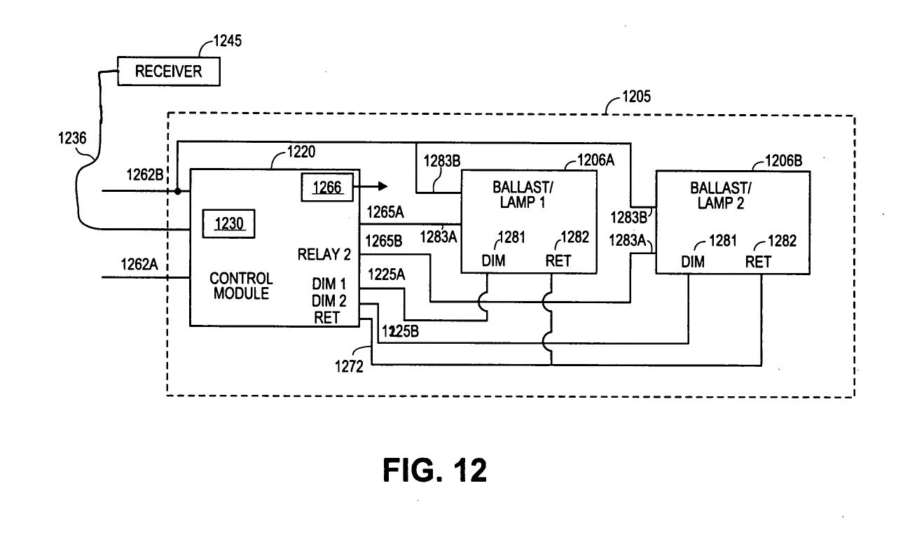

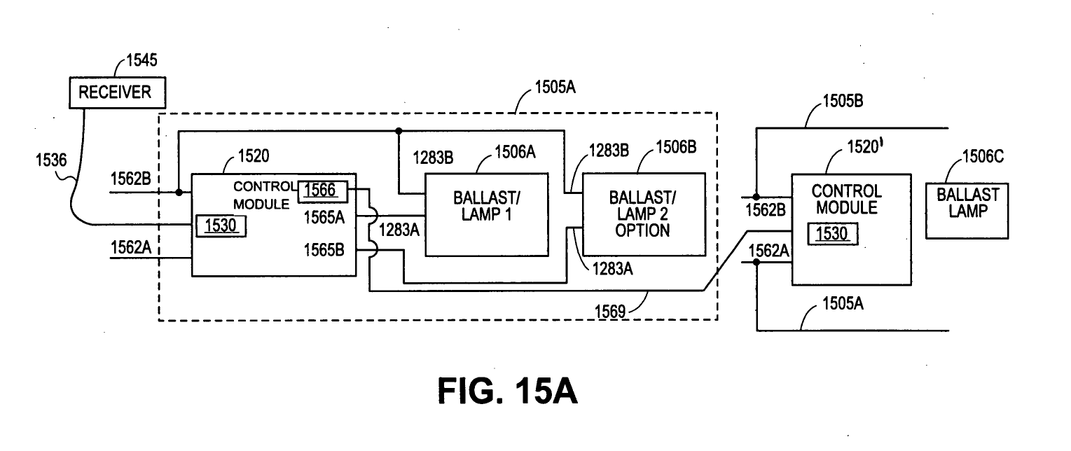

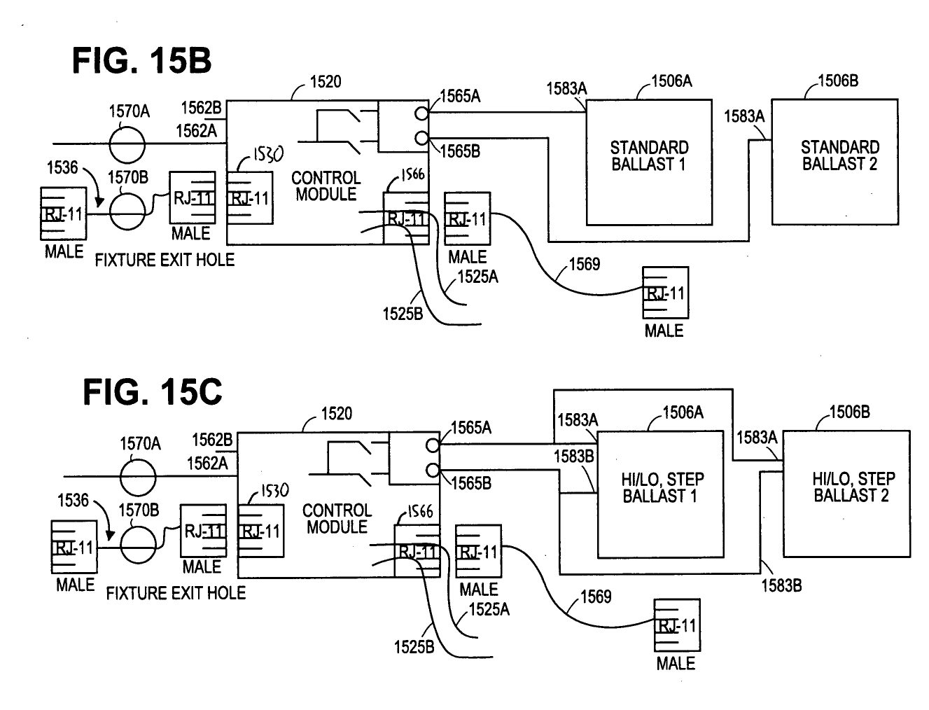

FIG. 12 illustrates a control module configured to control a plurality of ballasts in a light fixture. As shown control module 1220 can be housed inside a light fixture 1205 and be operably connected to ballast and lamp 1206A, and optionally ballast and lamp 1206B. Control module may be connected to an external power source via supply lines 1262A-B to receive power. In the illustrated embodiments, control module 1220 may provide power to an external receiver 1245 and receive information over a receiver interface 1230 connected to receiver 1245, by a cable 1236, such as a male to male RJ-11 cable, for example. In addition, a chaining interface 1266, such as a RJ-11 jack, can feed these same control signals to a control module that is down-stream (shown in FIG. 15A).

Ballasts 1206A-B can be full dimming ballasts, such as those having a dimming line 1281 and a return 1282. As shown, control module 1220 can be connected to control a two-ballast fixture having full independent on-off or full independent dimming control of each ballast. When non-independent dimming is desired, both dimming lines 1281 of each ballast could be paralleled and driven from either dimming line 1225A or 1225B of control module 1220 with the companion control module of the other ballast left unconnected. Return line 1282 of ballasts 1206A-B can also be connected to the return 1272 of control module 1220. Power supply line 1262B (ground) may also be connected to white lead lines 1183B of ballasts 1206A-B.

In addition, this configuration can also work for non-independent on/off control. In this embodiment, both on/off leads 1283A of the two ballasts 1206A-B can be tied in parallel and driven from either on/off relay 1265A or on/off relay 1265B outputs of the control module 1220. Additionally, the white lead 1283B of ballasts 1206A-B can be wired to ground via 1262B. Of note, although non-dimming ballasts may not include dimming 1281 and return 1282 inputs, these non-dimming “standard” ballasts can also be controlled by control module 1220 to have on/off control using a similar configuration.

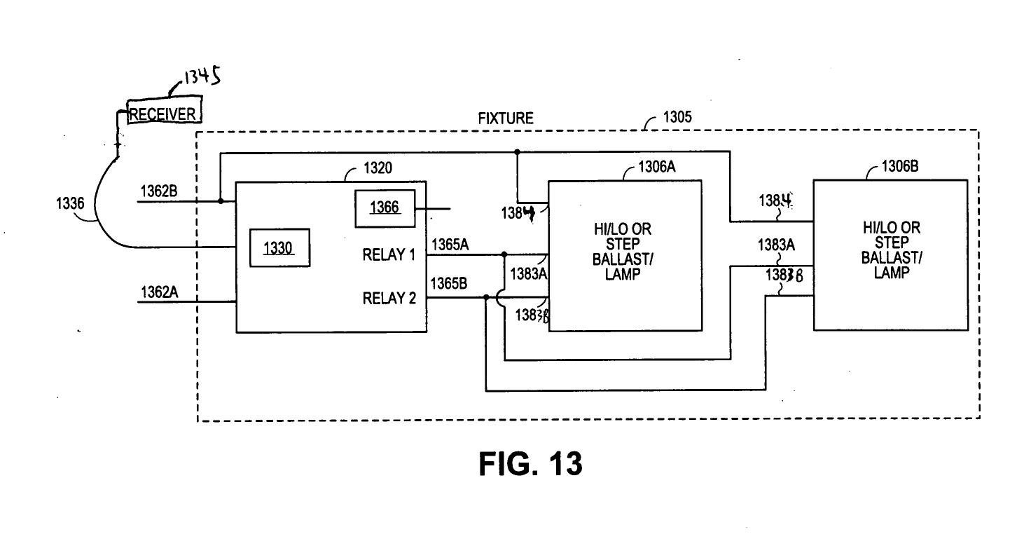

FIG. 13 illustrates a control module configured to control a plurality of different ballast types in a light fixture 1305. As described with respect to FIG. 12, control module 1320 can control a standard ballast having on or off control over the black and white power lines and full dimming ballasts which additionally have dimming and return lines. Additionally, control module 1320 may be connected to receiver 1345 via cable 1336 and receiver interface 1330 (as described above). With respect to FIG. 13, control module 1320 may also control high/low (hi/lo) or step ballasts 1306A-B. A hi/lo ballast may not include dimming or return lines, but may include two black leads 1383A-B and one white lead 1384. A step ballast may not include dimming or return lines either, but may include two black leads 1383A-B and one white lead line 1384 as well.

As shown, relays 1365A-B can be connected to black leads 1383A-B to control ballasts 1306A-B. In addition, power supply line 1362B can be connected to white lead line 1384 to fully interface ballasts 1306A-B. Advantageously, control module 1320 can then control hi/lo or step ballasts 1306A-B to provide a middle level of light control depending on which hot black-wire 1383A-B may be activated.

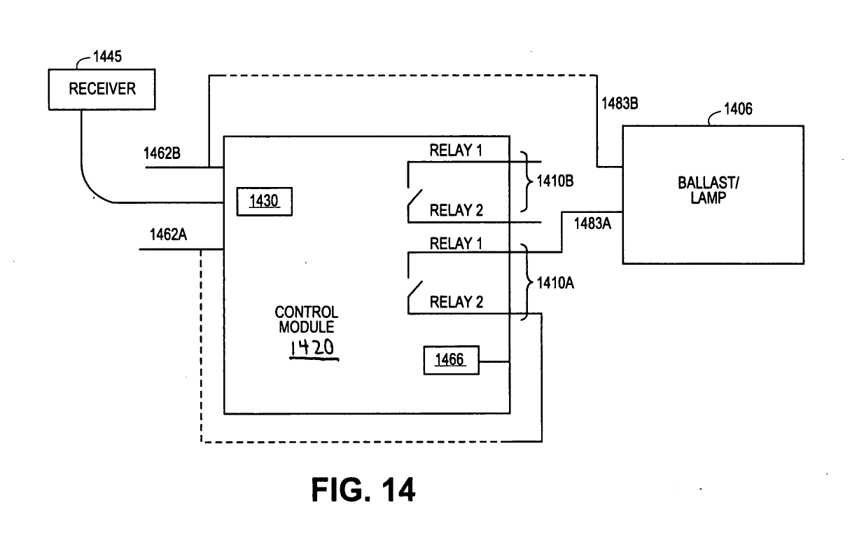

FIG. 14 illustrates a control module configured to control a ballast using dry contact relays. Control module 1420 can be housed inside a light fixture and connected to a receiver 1445 via an interface cable coupled to receiver interface 1430. Control module 1420 may include a pair of dry contact relays 1410A-B. As shown, dry contact relay 1410A may be coupled to a black lead line 1483A of ballast 1406 to control the ballast 1406. Power supply line 1462B (a white line) may then be connected to a white lead line 1483B of a ballast 1406.

Advantageously, the dry contact relays 1410A-B can provide several advantages when isolation may be needed of the relay from the power supply (not shown) of control module 1420. Additionally, when the control module 1420 power supply voltage (e.g. 120 VAC) may be different than the supply voltage to the ballast 1406 (e.g. 277 VAC), dry relay contacts 1410A-B can provide wiring convenience, emergency-wiring, or additional security.

FIGS. 15A-C illustrate a control module wired to control one or more light fixtures. In FIGS. 15A-C a control module 1520 includes a receiver interface 1530 and can be coupled to a receiver 1545 via a receiver cable 1536 to power the receiver 1545 and receive control signals. The power line 1562A and receiver cable 1536 can be run through separate fixture exit holes 1570A-B provided in light fixtures (best shown in FIGS. 15B-C). In addition, control module 1520 may include a chaining interface 1566 to daisy-chain itself to other control modules to relay control signals from a single receiver 1545, for example. Control module 1520 can also include relays 1565A-B to control ballasts 1506A-B. Further, power lines 1562A-B may be connected to external power sources to provide power to control module 1520′.

In FIGS. 15A-B, control module 1520 controls a plurality of light fixtures 1505A-B to provide on/off control for standard ballasts (although different ballast types can be used). Relays 1565A-B may be hot relay connectors which can be connected to black lead lines 1583A of ballasts 1506A-B of light fixture 1505A, respectively. Power line 1562B (white line) can be connected to white lead line 1583B of ballasts 1506A-B.

Chaining interface 1566 can be chained to a control module of light fixture 1505B via a chaining cable 1569. This can enable control ballast 1506C of light fixture 1505B to relay the control signals from receiver 1545 and allow master/slave control of lighting fixtures where the slave follows the master. A diode on a 12 Volt line (see FIG. 11), for example, which may be internal to each control module 1520, can be used to allow operation to occur without disruption.

In FIG. 15C, control module 1520 provides control for a plurality of ballasts 1506A-B, including high/low or step ballasts. Relays 1565A-B can be connected to black lead inputs 1583A-B of ballasts 1506A-B to provide a middle level of light control over ballasts 1506A-B. Control signals from receiver (not shown) can be provided to other high/low, step, on/off, or dimming ballasts by daisy-chaining the chaining interface 1566 using a chaining cable 1569 to another control module. Dimming signals 1525A-B can be sent over the chaining interface 1566 to provide control to dimming ballasts or on/off ballasts.

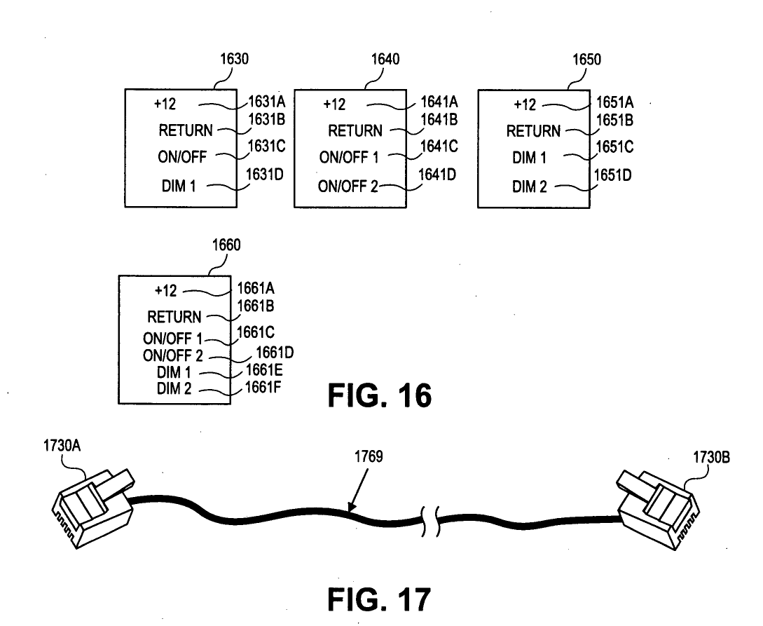

FIG. 16 illustrates exemplary interfaces of a control module. The control module may include interfaces 1630, 1640, 1650, and 1660 to send or receive input signals or provide power to a receiver or another control module. Interfaces 1630, 1640, 1650, and 1660 can be a jack with various input or output pins. In some embodiments, full functionality to control standard on/off, dimming, step, or high/low ballasts can be provided on an interface having 6 or more pins or conductors. In alternative embodiments, an interface having less than 6 pins or conductors, such as 4 pins can provide a subset of functionality, but at a reduced cost. Of note, a 4 pin interface and 6 pin interface can be retrofitted or used interchangeably with one another and any control module. Other options or configurations, such as for wiring jacks or plugs can also be used.

First interface 1630 may include pins 1631A-D. In some embodiments, first interface 1630 may have the following pin assignments, for example: pin 1631A may provide a power output, such as 12 Volts (V), pin 1631B can be a return line; pin 1631C may receive or provide a signal for controlling a standard ballast, such as 0 to 10 Volts (V); and pin 1631D may receive or provide a signal for controlling a dimming ballast.

Second interface 1640 may include pins 1641A-D. In some embodiments, second interface 1640 may have the following pin assignments, for example: pin 1641A may provide a power output, such as 12 Volts (V), pin 1641B can be a return line; and pins 1641C-D may receive or provide a signal for controlling a standard, step, or high/low ballasts, such as 0 to 10 Volts (V).

Third interface 1650 may include pins 1651A-D. In some embodiments, first interface 1650 may have the following pin assignments, for example: pin 1651A may provide a power output, such as 12 Volts (V), pin 1651B can be a return line; and pins 1651C-D may receive or provide a dimming signal for controlling dimming ballasts.

Fourth interface 1660 may include pins 1661A-F. In some embodiments, fourth interface 1660 may have the following pin assignments, for example: pin 1661A may provide a power output, such as 12 Volts (V), pin 1661B can be a return line; pins 1641C-D may receive or provide a signal for controlling a standard, step, or high/low ballasts, such as 0 to 10 Volts (V); and pins 1661E-F may receive or provide a dimming signal for controlling dimming ballasts.

FIG. 17 illustrates an exemplary interface cable employed in a lighting system. In the lighting system, the interface cable can be used to relay or daisy-chain one control module to another or connect a control module to a receiver. As shown, interface cable 1769 may include plugs 1730A-B provided on both sides of the cable. Plugs 1730A-B may carry signals or power from interfaces 1630, 1640, 1650, and 1660 as described above. Interface cable 1769 can be a RJ-11 cable, which can be constructed from both a wire and/or jacket insulation of flame-resistant polyvinyl chloride (FRPVC). Interface cable 1769 can be used for all low-voltage wiring in the lighting system. Alternatively, CM cable can be used. In embodiments where a building may have spaces with HVAC air-flow supply or return, a communications multi-purpose plenum (CMP) cable may be used. Of note, interface cable 1769 may be constructed from a wire insulation of FEP and a jacket insulation of FRPVC.

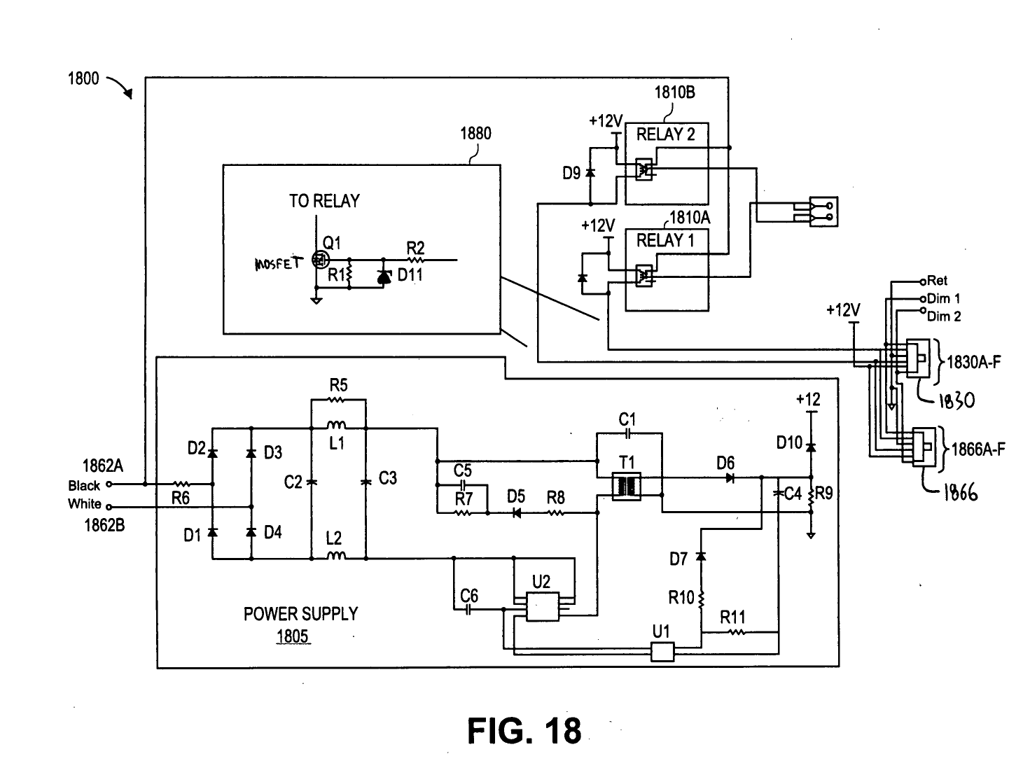

FIG. 18 illustrates another exemplary circuit which may comprise a control module. As shown, control module 1800 may include a power supply 1805 and primary power supply lines 1862A-B (see description of FIGS. 2A-B). In addition, control module 1800 may further include first and second relays 1810A-B, receiver interface 1830, and chaining interface 1866.

Receiver interface 1830 may include pins 1830-F. In some embodiments, pin 1830A may provide a power output to a receiver, such as 12 Volts (V), pin 1830B can be a return line; pins 1830C-D may receive a signal for controlling standard, step, or high/low ballasts, such as 0 to 10 Volts (V); and pins 1830E-F may receive a dimming signal for controlling dimming ballasts. Chaining interface 1866 includes pins 1866A-F which can be connected to pins 1830A-B of receiver interface 1830 to mirror or parallelize them for providing these signals to another control module.

First and second relays 1810A-B may be connected to one or more of the input pins provided by receiver interface 1830 to relay the signals provided. Each of the relays 1810A-B may be implemented as described with respect to FIG. 2A. In addition, relays 1810A-B can be implemented as hot relay connectors in addition to dry relay wires.

Optional low-voltage drive circuitry 1880 may also be used to reduce current consumption on a return line of chaining interface 1830 when daisy-chaining occurs. As shown, a MOSFET switch can be employed. A zener diode and resistors may also be employed to provide protection for the MOSFET. Of course, other semiconductor devices may be used, as described with respect to FIG. 2A. Although control module 1800 as illustrated may include certain isolators and active or passive elements, a variety of different elements can be used interchangeably depending on the embodiment. Additionally, control module 1800 can be implemented as a digital circuit.

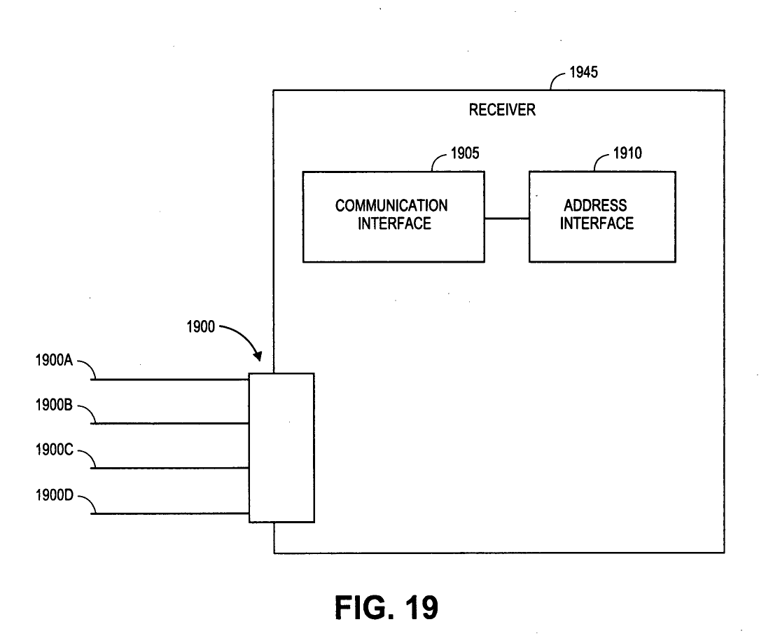

FIG. 19 illustrates a receiver employed to communicate with one or more sensors or switches. As shown, receiver 1945 may include a control module interface 1900, communication interface 1905, and address interface 1910. Control module interface 1900 may comprise a jack and have one or more inputs to receive power from a control module and outputs to provide control commands to a control module. When control module interface 1900 is coupled to a receiver interface of a control module via a cable, (see FIG. 17, for example), various control signals can be sent to control module and power may be received by receiver 1945.

In some embodiments, full functionality to control standard on/off, dimming, step, or high/low ballasts can be provided when control module interface 1900 has 6 or more pins or conductors. In the illustrated embodiment, control module interface 1900 has 4 pins with the following pin assignments, for example: pin 1900A may receive a power input, such as 12 Volts (V), pin 1900B can be a return line; pin 1900C may send a signal for controlling a standard ballast, such as 0 to 10 Volts (V); and pin 1900D may receive or provide a signal for controlling a dimming ballast. Alternatively, control module interface 1900 may be any of the interfaces described with respect to FIG. 16.

Communication interface 1905 can be a wireless interface (e.g. radio) and may receive messages from a transmitter which may be coupled to switches or sensors in the field. In addition, receiver 1945 may include an address interface 1910, such as a dip switch, to set addresses to identify receiver 1900 to various transmitters in order to receive messages to control light fixtures controlled by receiver 1945. The dip switch may have 8 positions to provide 256 addresses. Address interface 1910 can be set to identify a receiver 1945 which controls certain zones and groups to a transmitter. This can advantageously allow light emitted by one or more light sources associated with a zone or group to be controlled based on sensors or switches associated with the zone or group.

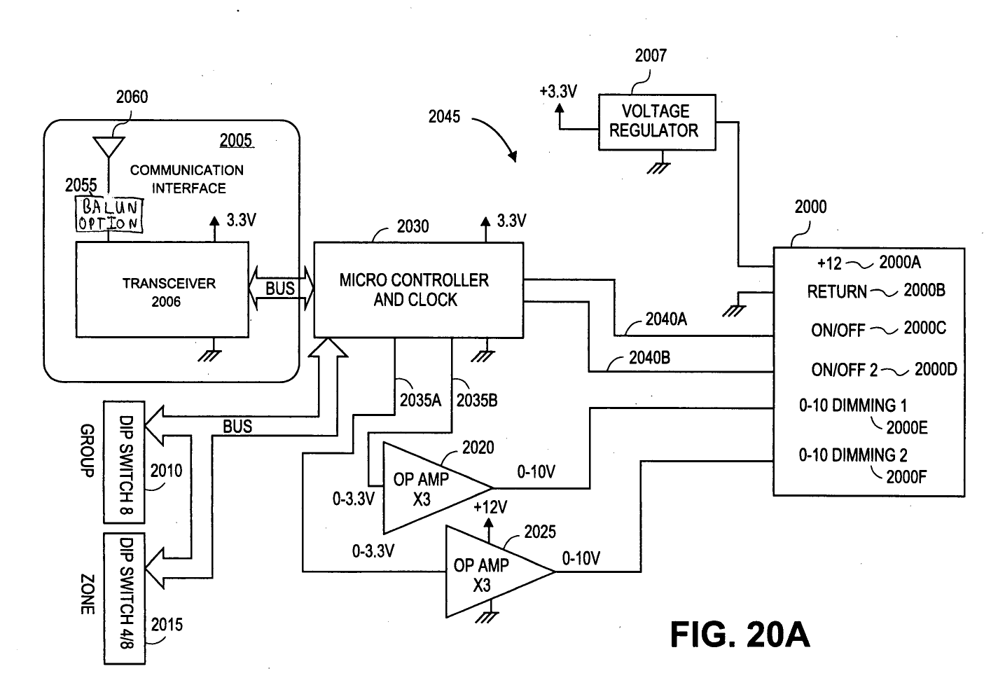

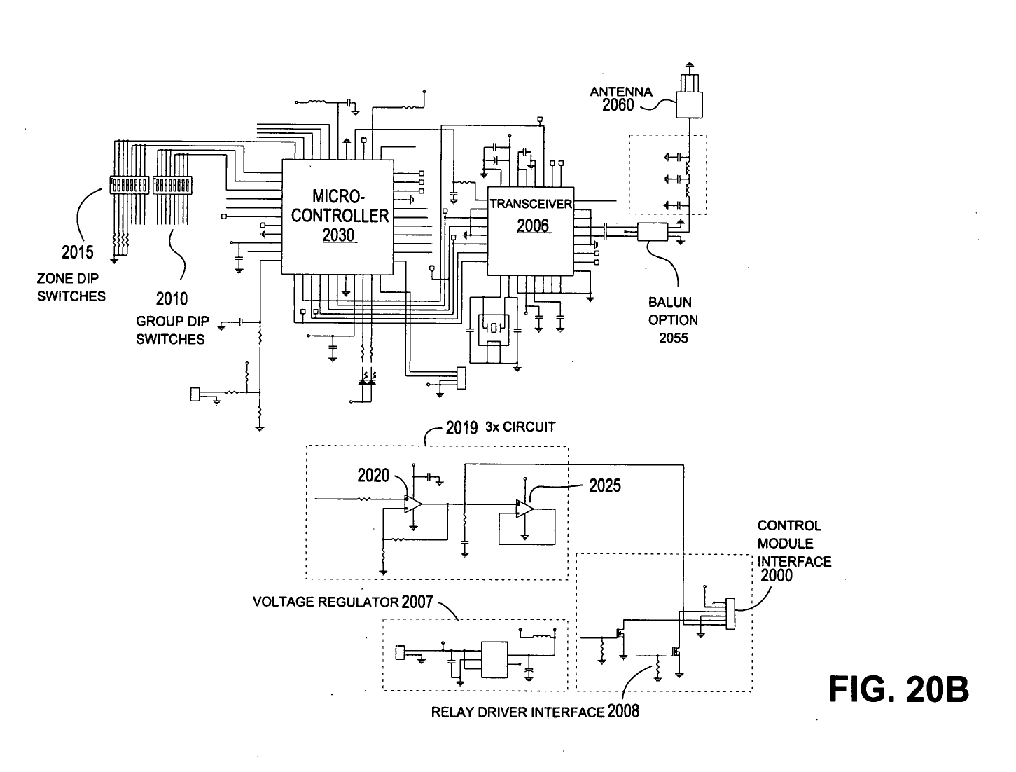

FIG. 20A illustrates a receiver capable of providing controls signals for any type of ballast. As shown, receiver 2045 can include a control module interface 2000, such as a jack with 6 pins 2000A-F. In addition, receiver can also include a communication interface 2005, voltage regulator 2007, group dip switch 2010, zone dip switch 2015, microcontroller or processor 2030, and operational amplifiers 2020 and 2025 which can be connected by one or more buses or wires.

Group 2010 and zone dip switches 2015 can provide a capability to group fixtures within zones of lighting, for example. In exemplary embodiments, group dip switches 2010 may offer 8 positions which can allow 256 addresses and zone dip switches 2015 may offer 4 or 8 positions.

Control module interface 2000 may be a jack that may be provided as an interface to a control module and can accommodate a 4 or 6 pin male to male jumper cable. As shown, control module may have the following pin assignments: pin 2000A can receive 12 volt power from a control module, pin 2000B can be a return, pins 2000C-D can provide on/off control signals to a ballast through control module, and pins 2000E-F can provide dimming signals, such as a 0 to 10 Volt dimming analog voltage to a ballast through a control module. In the configuration illustrated, two sets of on/off control signals 2000C-D may be provided as well as two sets of dimming signals 2000E-F.

Receiver 2045 typically receives signals from the various sensors and switches via communication interface 2005. Communication interface 2005 may include a transceiver 2006 and a reference crystal, in some embodiments. Transceiver 2006 may receive commands from various sensors or transmitters which communicate over radio airwaves to provide control signals to control light emitted by light fixtures, for example. These components may communicate via reception and transmission-confirmation to insure the integrity of signals. In some embodiments, to afford a level of redundancy radio portions associated with different transmitters and a receiver 2045 may act as repeaters to repeat signals to bridge gaps due to path-loss and interference issues.

Additionally, transceiver 2006 may be a direct sequence spread spectrum device. This can aid multi-path issues and offer some immunity to narrow-band jamming signals as the signals are spread. Transceiver 2006 may operate on a 915 MHz band and direct sequence spread spectrum. However, transceiver 2006 may also employ a different modulation scheme and operate on different frequencies.

Communication interface 2005 may also include an antenna 2060. In exemplary embodiments, transceiver 2006 receives signals, such as radio frequency (RF) signals, from transmitters over antenna 2060. In the illustrated embodiments, antenna 2060 can be a printed dipole; however, a loop, normal-mode helix, F, patch, monopole or other antenna configuration can be used. In addition, when driving unbalanced antennas, a balanced to unbalanced (balun option) 2055 RF transformer can be used to convert the balanced output of the transceiver 2006.

A microcontroller or processor 2030, may be used to control transceiver 2006 over a small bus. In some embodiments, microcontroller 2030 may be an Atmel microcontroller, however, other types of processors or controllers can be used. Microcontroller 2030 can decode messages received from transmitters or switches, read dip switches 2010 and 2015, and provide on/off relay 2000C-D and dimming signals 2000E-F.

The microcontroller 2030 may include a clock and inputs from zone and group dip switches 2010 and 2015 to identify a particular receiver 2045. In addition, microcontroller 2030 can include outputs for two relay commands 2040A-B which may be connected to pins 2000C-D of control module interface 2000. In the illustrated embodiments, microcontroller 2030 also outputs two signals 2035A-B, such as 0 to 3.3 Volts. Signals 2035A-B may be multiplied via operational amplifiers 2020 and 2025, such as by a factor of three, to generate dimming signals, such as 0 to 10 Volts, for control module. The multiplied signals may be connected to pins 2000E-F of control module interface 2000. Of note, the power provided by control module, such as 12 Volts, may be used by operational amplifiers 2020 and 2025 directly and converted to 3.3 Volts via a voltage regulator 2007 for transceiver 2006 and microcontroller 2030. Voltage regulator 2007 may be a standard voltage regulator integrated circuit (IC).

FIG. 20B illustrates an exemplary circuit which may comprise a receiver. Although the schematic illustrates transceiver 2006 as an integrated circuit (IC), a discrete design may be used. As shown, 3× circuit 2019 can be used to drive the dimmer lines 2000E-F of control module interface 2000. 3× circuit can be implemented using operational amplifiers 2020 and 2025 to multiply by three any DC level voltage via proper configuration of feedback resistors. Although a single feedback resistor is shown, another can be similarly hooked to the free pin of control module interface 2000.

As further shown, a relay driver interface 2008 can also be used. In some embodiments, the relay driver interface 2008 may not be needed if a low power driver option is being used on the control module. In this case, the driver 2008 on the receiver 2045 can be bypassed.

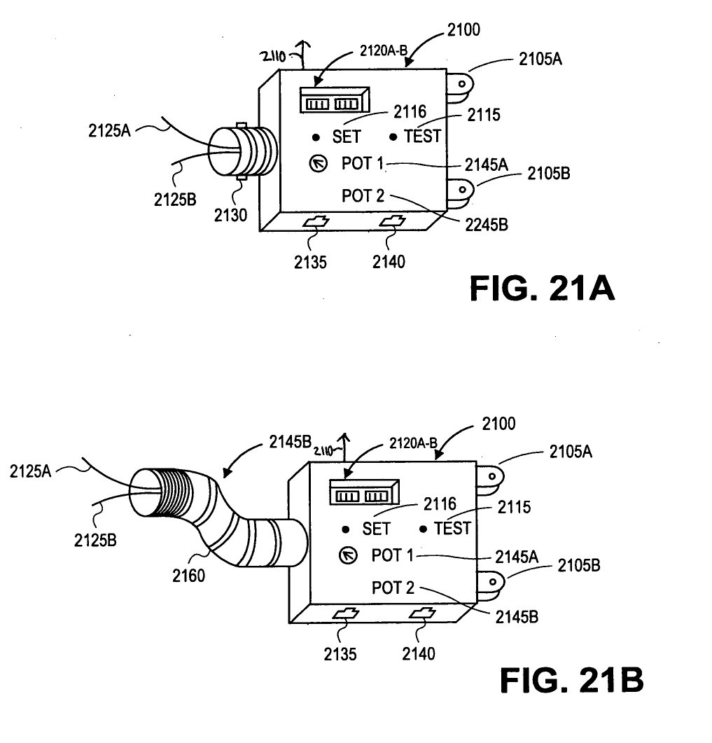

FIGS. 21A-B illustrate transmitters capable of transmitting control signals from one or more sensors. Transmitter 2100 can interface with one or more sensors and poll the sensors for data, process the data, and transmit the processed data to receivers to adjust the level of light emitted by light fixtures connected with the receivers. As shown, transmitter 2100 can include two sensor interfaces 2135 and 2140 to interface sensors, such as a motion or light harvest sensor. These interfaces may be a jack for plugs and cables that run to motion and/or light harvest sensors to pass signals or provide power, including those described with respect to FIGS. 16-17. Depending on the embodiment, a different number of sensor interfaces can also be used. Of note, transmitter 2100 may also operate when a single sensor may be plugged into sensor interfaces 2135 and 2140.

An integrated power supply (not shown) may be used, in which power, such as 85 to 277 VAC may be supplied by power lines 2125A-B, which can be black and white wires. As described with respect to control module, power supply (see FIGS. 2A-2B) may convert this power to 24 VDC. An integrated power supply, which may be provided inside transmitter 2100 can be used to reduce wiring. Alternatively, a non-integrated power supply, which may be provided external to transmitter 2100 by a sensor manufacturer, can be used to allow transmitter 2100 to be placed at a greater distance from sensors in the field.

Transmitter 2100 may also include a communication interface (not shown). Communication interface can include an antenna 2110, such as small stubby or integrated into the transmitter 2100 as a normal mode helix, patch, dipole, loop, inverted F, printed antenna, etc. As shown, transmitter 2100 also includes a light selection interface, such as two potentiometers 2145A-B and a set switch 2116, which can enable setting or controlling the parameters of a light harvest sensor connected to sensor interface 2135. In addition, transmitter may include an address interface 2120A-B, such as dip switches to select a zone or group of receivers to communicate with. Transmitter 2100 may also include a test switch or button 2115 which may be provided to exercise a test transmission to test receivers in communication with transmitter 2100 without having to wait for motion or light trip conditions, for example. This can be beneficial for setting up zone and group dip switches 2120A-B, for example.

In the embodiment of FIG. 21A, transmitter 2100 can include a threaded neck or nipple 2130 which can be inserted into a knock-out plug hole of a standard junction box. As shown in FIG. 21B, because many conduit boxes might be mounted in tight locations, a flexible neck 2160 version may also be used to connect to a junction box. For example the neck 2160 can be similar to a goose neck on a microphone or be a flexible conduit in plastic. The flexible neck 2160 may also be a hinged design. In FIGS. 21A-B, line voltage, such as 85 to 277 VAC enters through lines 2125A-B into neck 2130 or 2160 of transmitter 2100 and may be connected to an isolated power supply provided inside transmitter 2100. Transmitter may also include a transceiver, microcontroller, and other components described with respect to receiver and in further detail below. Mount holes 2105A-B can allow transmitter 2100 to be mounted on a wall or ceiling.

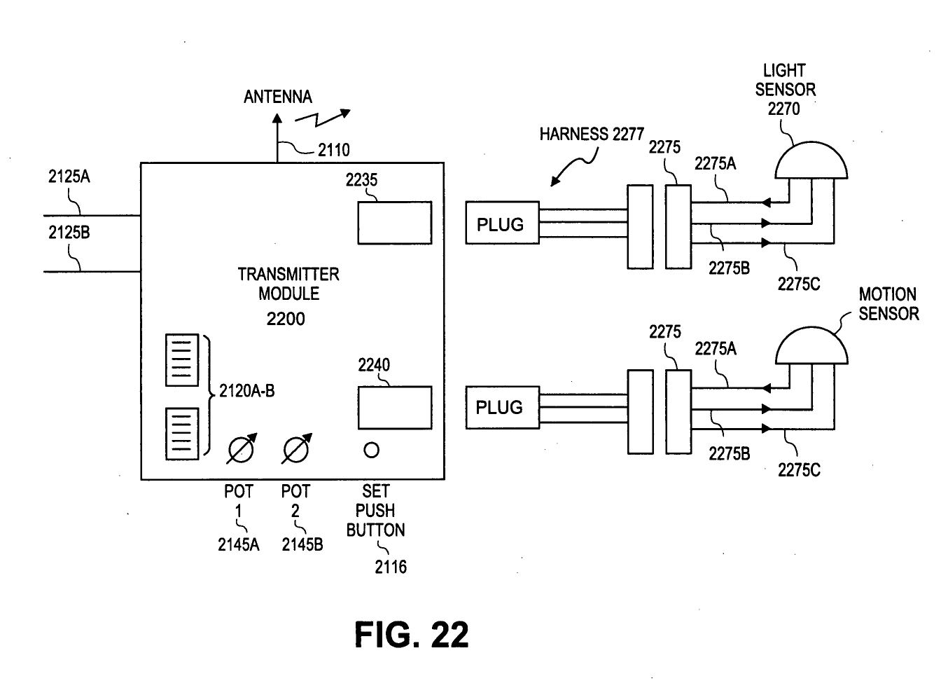

FIG. 22 illustrates an exemplary deployment of a transmitter and sensor. As shown, transmitter 2200 can be connected or wired to a light sensor 2270 through sensor interfaces 2235, 2240. Light sensor 2270 may include a connector 2275 (or a 3 pin pigtail). The signals carried by pins 2275A-C of connector 2275 can include 24 volts to power the sensor, a return, and a signal corresponding to light level, such as 0-10 Volts analog. A harness 2275 can be used to interface with connector 2275 and convert the pins 2275A-C of connector so it is compatible with a light harvest sensor interface 2235, such as a RJ-11 plug. Harness 2275 may then be connected to the light harvest interface 2235 of transmitter 2200.

In exemplary embodiments, a power supply (not shown) can be integrated into the transmitter 2110. When this occurs, the integrated power supply can be used to eliminate wiring, such as external wiring, or harnesses. The power supply may be substantially similar to the power supply described with respect to control module and convert power, such as 85 to 277 VAC, provided by supply lines 2125A-B into 24 VDC, for example.

Although deployment of transmitter is illustrated with a light sensor, other sensors can be used similarly. For example, when sensor is a motion sensor, the 0-10 Volt signal of connector 2275 can be replaced with a high or low voltage corresponding to when motion is detected. In addition, harness 2275 may then be used to connect to a motion sensor interface 2240.

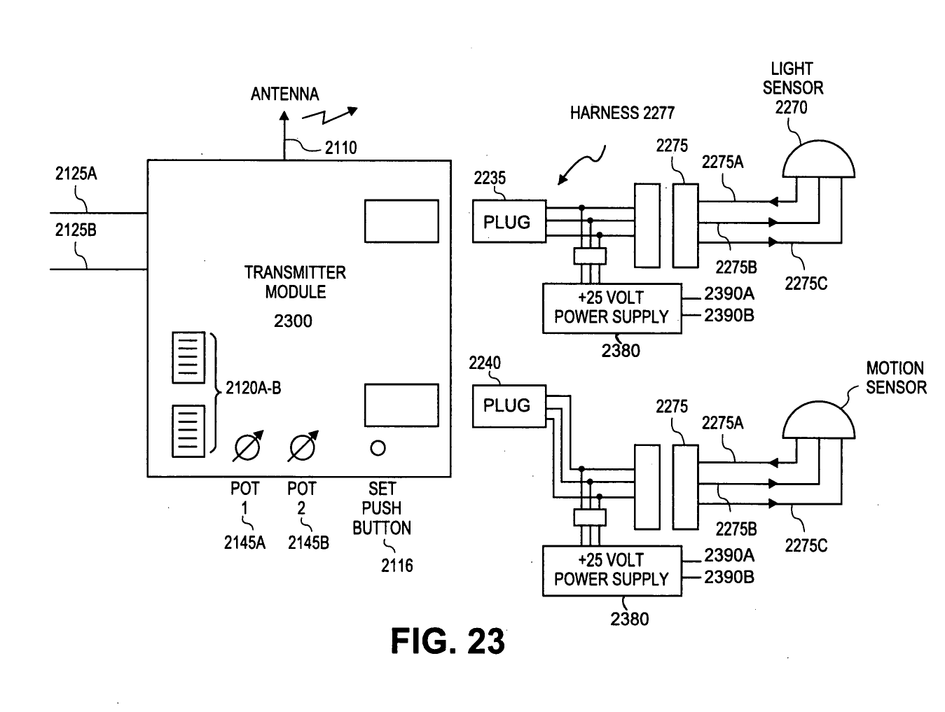

FIG. 23 illustrates another exemplary deployment of a transmitter and sensor. As further shown, operation and control in this deployment of transmitter 2300 and sensor 2370 may include a power supply 2380 (non-integrated) which may be used to supply power, such as 24 VDC, to sensor 2270 and transmitter 2300 after receiving power, such as 85 to 277 VAC from supply lines 2390A-B. Harness 2275 may also be connected to power supply 2380. The external power supply 2380 may be substantially similar to the power supply described with respect to control module or be a power supply provided with sensor 2370 by a manufacturer, for example. A single power supply 2380 of 24 Volts can be used to power multiple sensors. When multiple power supplies are used (for example, when two or more sensors are used), harnesses may be connected to each of the power supplies.

A non-integrated power supply 2380 can advantageously allow transmitter 2300 and sensor 2270 to be tethered away from each other and from power supply 2380 because the supply 2380 is not integrated with transmitter 2300. Thus, the sensor 2270 can be mounted optimally and the transmitter 2300 can be optimized for a location best suited for radio reception. In some embodiments, when sensor 2270 and power supply 2380 may be matched together, power supply 2380 may have a control interface that takes an action in response to the sensor 2270, i.e. switches a load, provides low-voltage signals to another remote wired controlling unit, etc. Because a conventional cable running between power supply 2380 and sensor 2270 may have 3 pin connectors on each end, only localized sensing (not wireless) may occur. Accordingly, a Y-harness 2277 having an RJ-11 jack on one end and two 3-pin connectors, can be used to allow sensor 2270 to be made wireless. Power supply 2380 may thus be Y connected to power both the sensor 2270 and transmitter 2300. In addition, control signals from sensor 2270 can be Y connected to run to transmitter 2300. Transmitter 2300 can then interpret and send commands wirelessly to a receiver at a remote location. This can advantageously allow transmitter 2300 to be plug and play and retrofit with sensor 2270 without the design of sensor 2270 or power supply 2380 being changed.

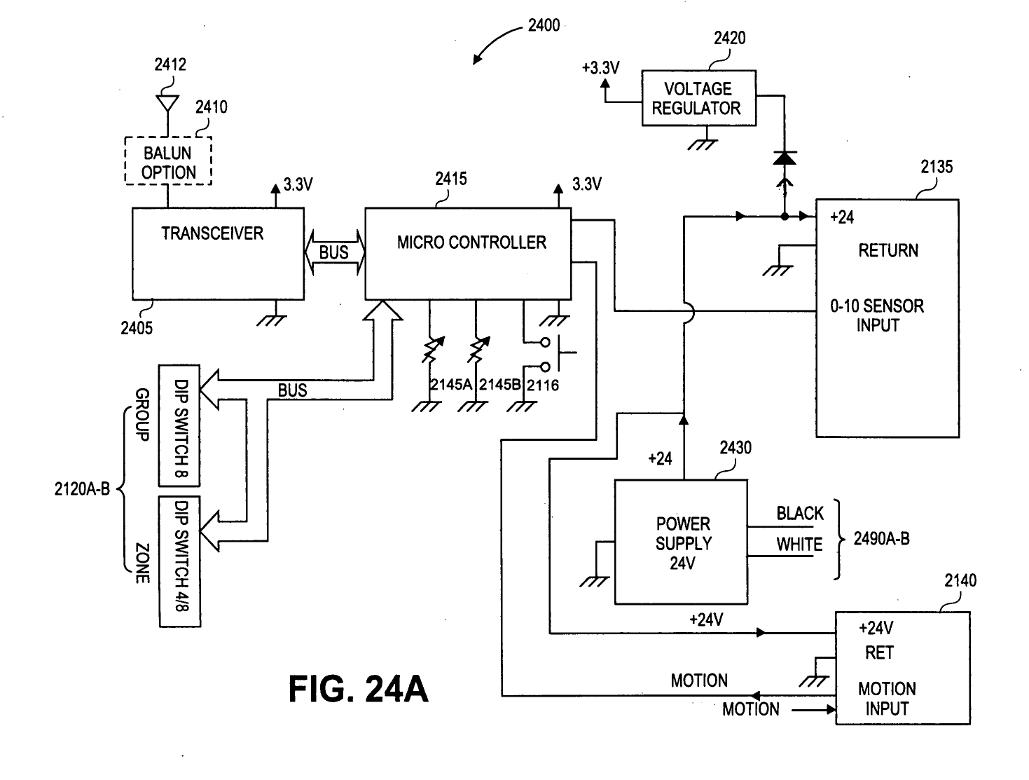

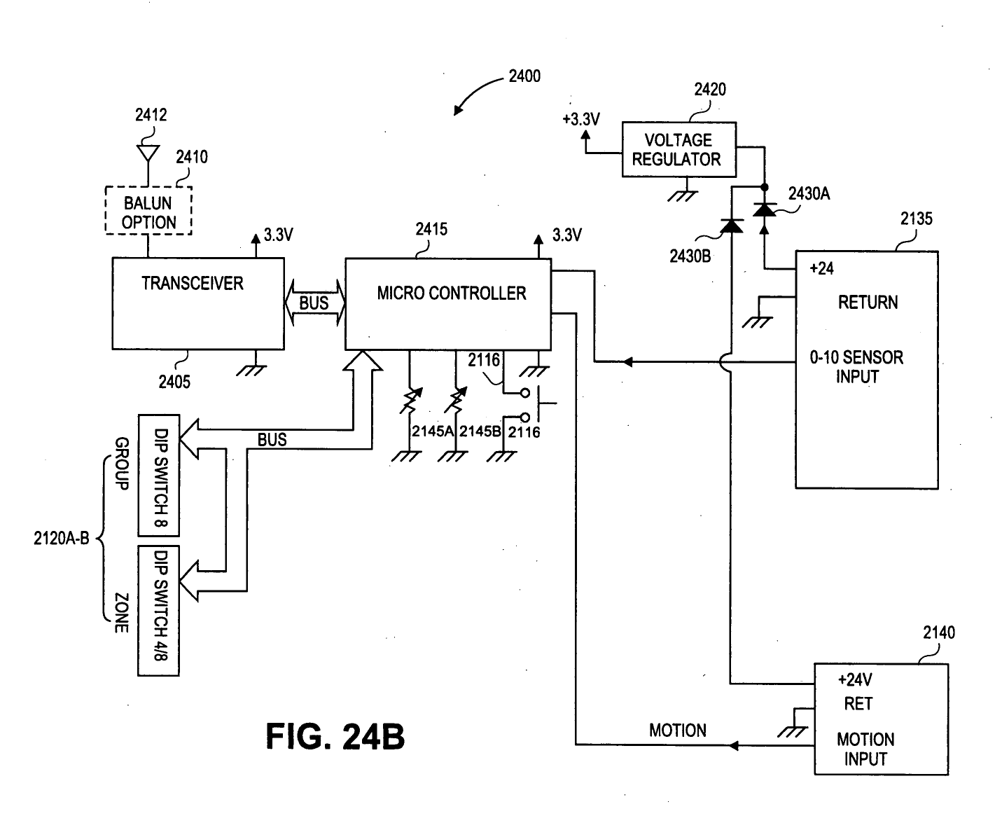

FIGS. 24A-B illustrate exemplary circuits which may comprise a transmitter. As shown, transmitter 2400 may include a transceiver 2405, address interface 2120A-B (dip switches), antenna 2412, an optional balun 2410, microcontroller 2415, and voltage regulator 2420. In addition, transmitter 2400 may comprise a dimness selection interface which may include potentiometers 2145A-B and a set switch 2116 which may be routed as input to a harvest light sensor, for example, by microcontroller 2415. These components may operate similar to components of a receiver (as described above in FIGS. 20A-B) and be connected via wires or buses. For example, transceiver 2405 may be controlled by microcontroller 2415 over a small bus. Microcontroller may have inputs from dip switches 2120A-B which set zone and group addresses to identify transmitters or receivers to send to. In addition, these and other components of transmitter 2400 can be configured to receive input from sensors, such as light readings in repeating time intervals, process those input signals into control signals, and transport the control signals to receivers to control light fixtures using a communication interface, including transceiver 2405, balun 2410, antenna 2412, for example.

Transceiver 2405 can be a direct sequence spread spectrum 915 MHz band integrated circuit (IC). However, other frequencies and other modulation schemes, or frequency hopping can be used by transceiver 2405. In addition, motion and 0-10 Volt inputs signals may come from the motion 2140 and light-harvest 2135 interfaces respectively. An addressing interface 2120A-B, such as two dip switches for setting zones and groups and a SET switch 2116, may be used for light harvest adjustment control by an installer, for example.

In FIG. 24A, a universal power line inputs 2490A-B, such as 85 to 277 VAC, may be isolated and converted to 24 VDC by power supply 2430. The converted power can be fed to sensor interfaces 2135, 2140 from power supply 2430 to power sensors and the on-board voltage regulator 2420 for the transceiver, microcontroller, etc. via a 3.3 Volts voltage regulator. In FIG. 24B, operation and controls are similar to FIG. 24A, however external power may be supplied from an external power supply (not shown) of 24 Volts, for example. This external power supply may be a power supply coupled to sensor which may be provided by a manufacturer or substantially similar to that described with respect to control module. In addition, if a diode on the 24 Volt output of an external power supply (see FIG. 23) is utilized, then diodes 2430A-B can be replaced with shorts.

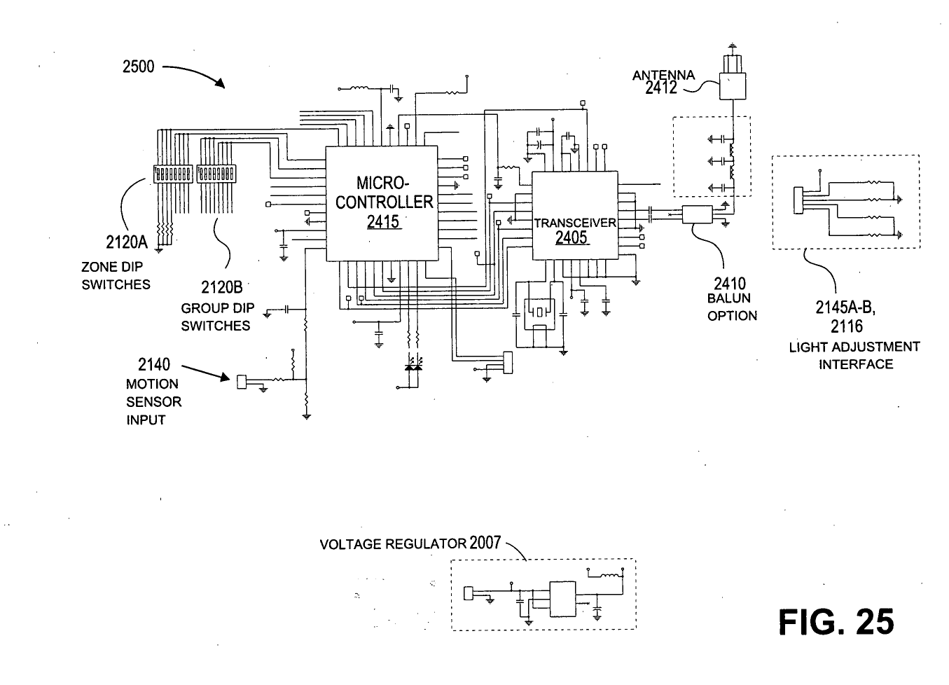

FIG. 25 illustrates a circuit schematic which may comprise a transmitter 2500. Although the schematic illustrates transceiver 2500 as an integrated circuit (IC), a discrete design may be used. As shown, an address interface can be implemented as a set of dip switches 2120A-B to organize light fixtures into a serious of zones and groups within a zone to provide additional control. Selections from potentiometers 2145A-B and a set switch 2216 interface can be routed as input signals to a light harvest sensor via sensor interface 2135 or be used to control commands to adjust levels of light emitted by a light fixture. In addition, motion input signals from a motion sensor can be received over sensor interface 2140 and sent to microcontroller 2415. Microcontroller 2415 may then send control commands to receiver using a communication interface, such as transceiver 2405, balun 2410, and antenna 2412. Transmitter 2500 may also include an integrated power supply or non-integrated power supply (see FIG. 2B) and a voltage regulator 2007.

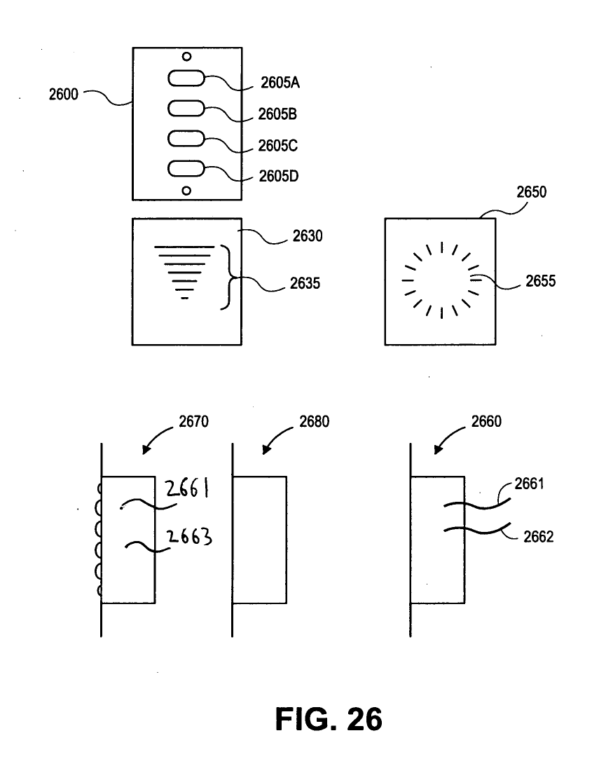

FIG. 26 illustrates exemplary switches which may be employed in a lighting system. Switch 2600 can be used to augment a system where a sensor may receive an input, transmit it via a transmitter and a receiver may pick up the signal and direct a control module to adjust a ballast accordingly. For example, switch 2600 can replace or augment sensors in a room which can allow the user wireless manual control of lights. From the perspective of functionality to a user of a lighting system, the switch can be substantially similar to the transmitter described above because it can transmit a user-switched state. The transmitter employed includes a microcontroller which decodes messages from various switches, such as a touch switch integrated circuit, reads dip switches, and provides messages for the transceiver to transmit.

As shown, a variety of switches 2600, 2630, 2650 can be used. Switches 2600, 2630, 2650 can be a standard wall-plate type device meant to fit into a standard wall-plate box and may retrofit into existing lighting applications or be used in new construction. In addition, switches may be placed on a remote control device to communicate with receivers. Switches 2600, 2630, 2650 may include a transmitter (not shown) to transmit commands, a power supply (integrated or non-integrated), and various interfaces, such as a touch interface. For example, switches 2600, 2630, and 2650 may include a transceiver which offers full handshaking to insure reception and act as a repeater for other signals on a wireless network, as described with respect to receiver and transmitter above.

Switches 2600, 2630, 2650 illustrate a front view of the switches. As shown, switch 2600 can include a variety of buttons 2605A-D to provide varying amounts of control over light levels, such as on/off, or to control multiple lighting fixtures, zones, or groups. A backlight can also be provided using a LED. Switches 2600, 2630, 2650 can be mechanical, such as push button, snap dome, membrane, etc., or be capacitive touch switches. As further shown, switch 2630 can include a slider interface 2635 for sliding control and switch 2650 may include a rotary interface 2655 for variable level control options. Switches 2630 and 2650 may be implemented mechanically using a rotary or slide potentiometer or be touch switch-based. In some embodiments, because touch switches may offer no tactile feedback, other interfaces may be employed to provide feedback. For example, LED backlighting can be used whereby a LED indicates some kind of change in light settings. In addition, audible sounds may be used, such as a piezo speaker beeper or buzzer.

When switches 2600, 2630, and 2650 are employed in conjunction with wall switch boxes various types of wiring for power can be used. In an embodiment, when a mechanical switch is not present, the wall box 2660 may only include two wires: one hot lead 2661 and one lead running to a load—a neutral wire 2663, such as a white wire, may not be present. As shown in the configuration of 2660, in order to derive power without the neutral wire 2663, power can be derived from the black hot lead 2661 and ground 2662 of the wall box 2660, such as a green wire. When this occurs the leakage current used may be approximately 500 microamperes.

In other embodiments, when support for higher currents may be needed by switches 2600, 2630, and 2650, a power storage device, such as a battery 2680 (e.g. rechargeable), or super cap may be used by switches for power. Alternatively, when wall switch box 2670 includes a hot lead 2661 and neutral wire 2663 available, a direct power conversion technique can be used, although transformers or switching supplies may also be employed. In another embodiment, low-voltage wiring, such as class 2 wiring, may be run to the wall switch box to power switches 2600, 2630, and 2650.

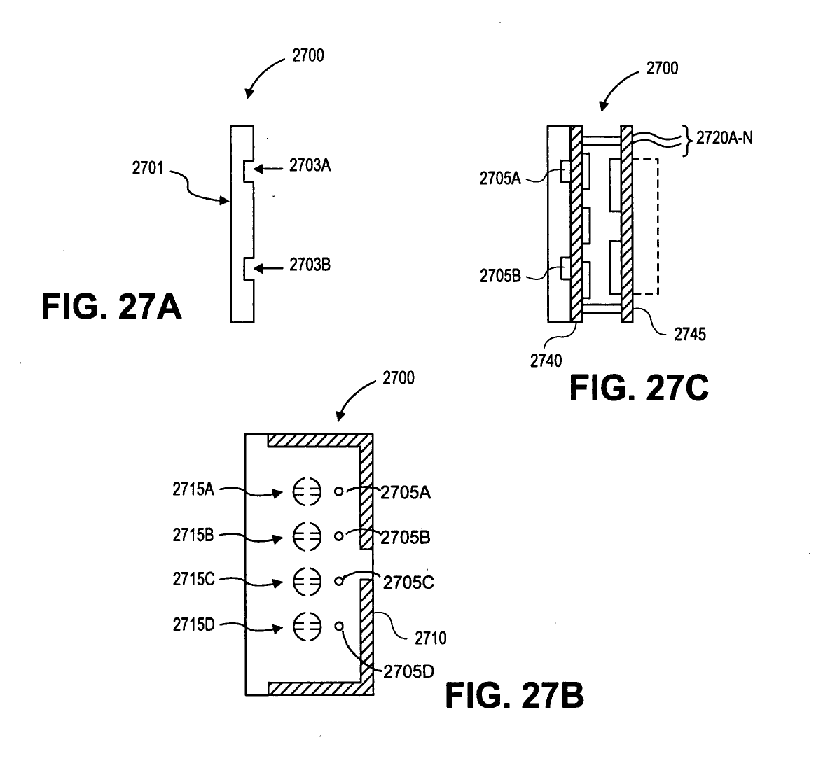

FIGS. 27A-C illustrate exemplary assemblies for a switch. As shown in FIG. 27A, the switch assembly 2700, such as for a touch switch, may include a front plate 2701. The front plate 2701 can be made from plastic and be decorative. In addition, front plate 2701 may also include substantially opaque or transmissive plastic portions to cover LEDs 2705A-B, which may be placed on a printed circuit board of switch and indicate status of the lighting system. In some embodiments, front plate 2701 may further include small protrusions or indentations 2703A-B to allow LEDS 2705A-D which may be positioned below to be housed. As depicted in FIG. 27B, the switch assembly 2700 may be coupled to an antenna 2710, such as a printed dipole, to communicate with one or more receivers. In addition, switch assembly 2700 may include one or more touch pad tracks 2715A-D to adjust light settings which can be sent to receivers.

In FIG. 27C, a switch assembly 2700 is shown which can fit inside a thin-wall plastic box. Switch assembly 2700 includes a front plate 2701 placed over a printed circuit board, and wires 2720A-N which can connect to a wallbox, for example. The switch assembly 2700 may have a main board 2740 and a power supply board 2745 which form a printed circuit board sandwich. Power supply board 2745 may have wires 2720A-N that exit for hookup, and/or a battery or supercap. Power supply board 2745 can further include flex or jumper pins which connect to the main board 2740. The main board 2740 may be a double sided board and have a first side that faces the power supply board 2745. This first side of main board 2740 may include many of the components of the switch assembly 2700, such as a radio, microcontroller, touch switch, etc.

On the other side main board 2740, which may face in the direction of a user of the switch, other components may be provided. For example, traces for touch switch pads 2715A-D, a printed radio antenna 2710, and LEDs 2705A-D may advantageously be surfaced mounted or positioned on this side because it faces the user. Additionally, antenna traces 2710 may reside on this side of main board 2740 in order to transmit radio frequency (RF) signals because shielding may be reduced. The front cover 2701 may include indentations 2703A-B for LEDs 2705A-B which may be flush-mounted to the printed circuit board. The touch switches 2715A-D may be substantially light-transmissive through plastic. In exemplary embodiments, the plastic used may be substantially opaque to allow for some diffusion of light from LEDs 2705A-B.

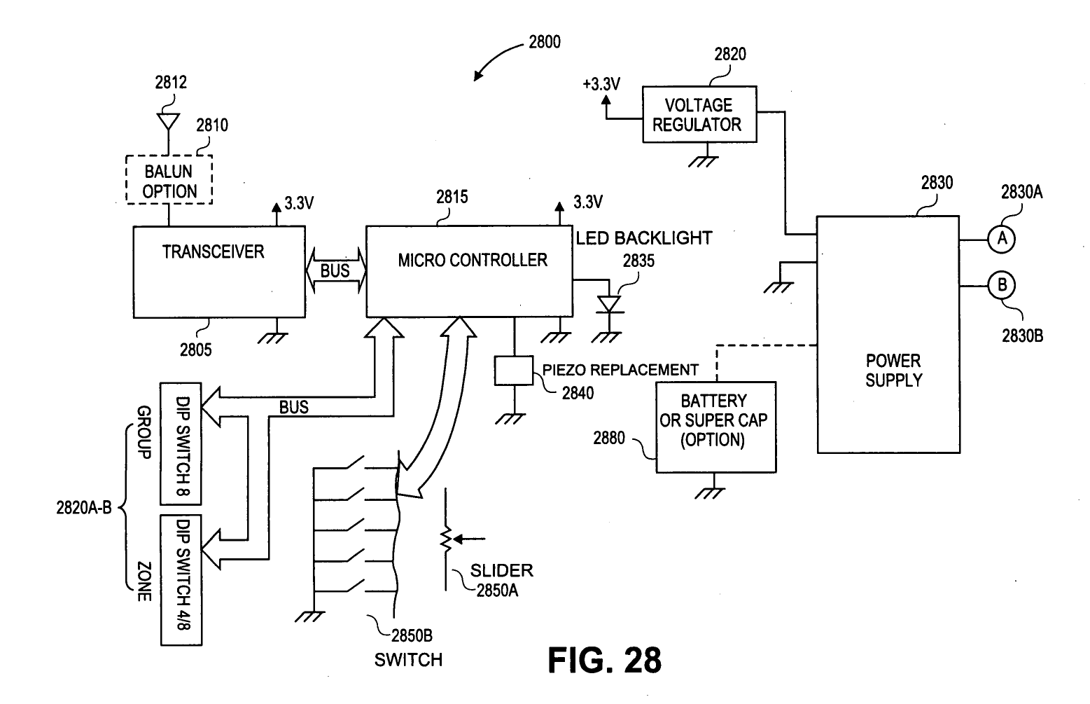

FIG. 28 illustrates an exemplary circuit which may comprise a switch. As shown, switch 2800 may include a transceiver 2805, antenna 2812, balun 2810, microcontroller 2815, and voltage regulator 2820. These components may operate similar to components of a receiver and transmitter (as described above in FIGS. 20A-B and 24A-B) and be connected via wires or buses. The transceiver 2805 may be controlled by microcontroller 2815 over a small bus. The power supply 2830 can be powered in a variety of ways from wiring from a wall box. For example, power supply lines 2830A-B can be black and white power lines, black and ground lines which may provide leakage power, or low voltage power lines. In an embodiment, when supply lines 2830A-B may be connected to hot and neutral wires, a direct line conversion power supply 2830 may be provided, which can use a capacitor as a voltage dropping element and consumes a substantially small amount of power. In addition, a battery 2880 may be used depending on power available and the duty cycle of the power consumed by circuitry (see FIG. 26).

The switch interfaces 2850A-B used may be mechanical or touch-switches. In some embodiments, switch interfaces 2850A-B may connect directly to microcontroller 2815. Alternatively, switch interfaces 2850A-B can be connected through a separate integrated circuit, such as for a touch-switch, which runs via a small bus to microcontroller 2815. Switch 2800 may include a LED backlight 2835 to provide feedback to a user to indicate a change in settings, such as for light controls. In addition, switch 2800 may include a piezo replacement 2840 to provide tactile feedback for a capacitive touch switch, for example.

In addition, these and other components of switch 2800 can be configured to receive input from users, process those inputs into control signals, and transport control signals to receivers in order to control light fixtures using a communications interface, such as transceiver 2805, balun 2810, and antenna 2812 for example. Transceiver 2805 can be a direct sequence spread spectrum 915 MHz band integrated circuit (IC). However, other frequencies, modulation schemes, and frequency hopping can be used by transceiver 2805. In addition, an addressing interface such as dip switches 2820A-B may be used to select receivers in certain groups and zones to send control signals to from switch 2800.

It will be apparent to those skilled in the art that various modifications and variations can be made in the present disclosure without departing from the spirit or scope of the disclosure. Thus, it is intended that the present disclosure cover any modifications and variations within the scope of the appended claims and their equivalents.

What is claimed is:

1. A control module for controlling one or more light sources, the device comprising:
one or more inputs operable to receive control signals configured to control a level of light emitted by the one or more light sources from a receiver; and
one or more interfaces configured to provide one or more output signals which provide controls for the one or more light sources based on the received control signals.

2. The control module of claim 1, further comprising a power supply operable to power the receiver.

3. The control module of claim 1, wherein the one or more output signals provide dimming control to at least one ballast of the one or more light sources.

4. The control module of claim 1, wherein the one or more output signals provide on or off control to at least one ballast of the one or more light sources.

5. The control module of claim 1, wherein the one or more output signals provide step control to at least one ballast of the one or more light sources.

6. The control module of claim 1, wherein the one or more output signals provide high or low control to at least one ballast of the one or more light sources.

7. The control module of claim 1 having at least two interfaces, each of the at least two interfaces configured to relay the one or more output signals.

8. A receiver for controlling a lighting area, the receiver comprising:
a first interface which receives one or more commands to control light emitted by one or more light sources associated with the lighting area from a transmitter; and
a second interface which provides one or more output signals configured to control an amount of the light emitted by the one or more associated light sources based on the one or more commands.

9. The receiver of claim 8, wherein the first interface is associated with an address to identify the receiver.

10. The receiver of claim 9, wherein the address is adjusted by setting by a dip switch.

11. The receiver of claim 8, wherein the second interface is configured to provide the one or more output signals to a control module when connected.

12. The receiver of claim 11, further comprising a power input configured to be coupled to a control module to receive power.

13. A transmitter for controlling a lighting area, the transmitter comprising:
a sensor input configured to receive a signal from a sensor; and
a controller which converts the sensor signal into one or more control signals to control a level of light emitted by one or more light sources in the lighting area based on at least the sensor signal.

14. The transmitter of claim 13, further comprising a wireless interface configured to send the one or more control signals to one or more receivers configured to control the one or more light sources.

15. The transmitter of claim 14, further comprising at least one address selection interface to select addresses assigned to the one or more receivers to send the one or more control signals.

16. The transmitter of claim 15, wherein the at least one address selection interface comprises a dip switch.

17. The transmitter of claim 13, wherein the transmitter further comprises an output configured to provide power to the sensor.

18. The transmitter of claim 13, wherein the sensor signal corresponds to a measurement of a ambient light.

19. The transmitter of claim 13, wherein the sensor signal corresponds to whether motion is detected.

20. The transmitter of claim 13, wherein the sensor signal corresponds to the time of day.

21. The transmitter of claim 13, further comprising a dimness selection interface to adjust the level of light emitted by the one or more light sources based on the sensor signal, the controller further configured to control the level of light based on both the adjustment of the dimness selection interface and the sensor signal.

22. The transmitter of claim 13, wherein the dimness selection interface comprises a potentiometer.

23. A lighting system for reducing energy consumption, the lighting system comprising:
one or more light fixtures, each of the light fixtures including at least one ballast and at least one lamp;
a receiver including a wireless interface which receives one or more commands to control a level of light emitted by the at least one lamp; and
a control module operatively coupled to the receiver to receive as input one or more control signals based on the commands received by the receiver and including a control interface configured to provide one or more output signals based on the one or more control signals to the at least one ballast.

24. The lighting system of claim 23, wherein the receiver is configured to be positioned outside the one or more lighting fixtures.

25. The lighting system of claim 23, wherein the control module is configured to be positioned inside the one or more light fixtures.

26. The lighting system of claim 23, further comprising a transmitter configured to send the one or more commands to the receiver.

27. The lighting system of claim 26, wherein the transmitter further comprises a sensor input configured to receive a sensor signal from a sensor and a controller which converts the sensor signal into the one or more commands based on at least the sensor signal.

28. The lighting system of claim 26, wherein the transmitter further comprises a switch input configured to receive a switch signal from a light switch and a controller which converts the switch signal into the one or more commands based on at least the switch signal.
